(19) United States
(12) Patent Application Publication
(10) Pub. No.: US 2016/0251602 A1
(43) Pub. Date: Sep. 1, 2016

(54) METHOD OF TREATING A METAL SUBSTRATE

(71) Applicant: Xeros Limited, Rotherham (GB)

(72) Inventors: John Edward Steele, Rotherham (GB); Robert Andrew Bird, Rotherham (GB)

(73) Assignee: Xeros Limited, Rotherham (GB)

(21) Appl. No.: 14/902,506

(22) PCT Filed: Mar. 3, 2014
(86) PCT No.: PCT/GB2014/050621

§ 371 Date: Dec. 31, 2015

(30) Foreign Application Priority Data
Jul. 5, 2013 (GB) 1312159.5

(51) Int. Cl. C11D 11/00; C11D 3/20; C11D 3/28; C11D 3/00; B24C 1/00; B08B 3/08; B08B 7/00; B08B 3/10; C23C 26/00; C11D 3/37; C11D 17/00

(52) U.S. Cl. CPC C11D 11/0029; C11D 3/3719; C11D 3/3749; C11D 3/2086; C11D 3/28; C11D 3/0073; C11D 3/3715; C11D 17/0013; B08B 3/08; B08B 7/00; B08B 3/102; C23C 26/00; B24C 1/00

(57) ABSTRACT

A method of cleaning a metal substrate, the method comprising exposing the metal substrate to a body of cleaning liquor comprising a cleaning formulation and a multiplicity of solid particles wherein the method further comprises causing the solid particles and the metal substrate to enter into contacting relative movement; wherein i) the cleaning formulation comprises at least one acid which has a pKa greater than about −1.7; and/or ii) the cleaning formulation comprises at least one base which has a pKb greater than about −1.7; and the length of the particles is from about 0.5 mm to about 6 mm.

Embodiments of this invention relate to a method of treating a metal substrate The treatment can comprise cleaning the metal substrate by contacting the substrate with a material comprising or consisting a multiplicity of solid particles. The multiplicity of solid particles can be included in a treatment liquor. The solid particles can facilitate removal of undesired materials, such as contaminants, from the surface of the metal substrate.

### BACKGROUND

Metal substrates can be, or can become, contaminated for various reasons. One common cause of contamination is earlier treatment processes in forming or modifying the metal substrate. As a result of such earlier treatment processes, the metal substrate surface can carry contaminants such as fines (small particles of the metal) and smut, lubricants such as oils and lubricant residues, coolant residues, inorganic or organic salts, surfactants, biocides, emulsifiers and fungicides. Some or all of these materials can require removal prior to subsequent further treatment or modification of the metal substrate.

Current methods for cleaning metal substrates often require large quantities of water in combination with aggressive conditions and toxic chemicals. For example, when cleaning the surfaces of metal substrates, strongly acidic compositions are generally required to elicit an effective cleaning action. The use of such aggressive conditions and toxic chemicals presents a number of problems including the disposal of environmentally hazardous effluent produced from the process.

As an alternative to processes involving aggressive and/or corrosive compositions, abrasive cleaning methods are sometimes used. However, conventional abrasive methods, for example sand blasting processes, tend to be only temporarily effective and can damage the substrate. Furthermore, abrasive cleaning methods may not achieve consistency of removal of excess material from the substrate, leading to a non-uniform surface.

Surface uniformity can be important when metal substrates are to undergo additional treatments such as the application of one or more coatings or lacquers following cleaning. Conventional aluminum production processes, and particularly those for the production of aluminum cans, therefore include one or more cleaning steps for cleaning the metal substrate surface requiring a number of rinsing steps with water and such processes further incorporate strong acids and surfactants. The use of large quantities of water in combination with such ingredients is necessary to displace materials such as smut and oils from the surface of the metal.

Following the initial surface cleaning and rinsing treatments, substrates in conventional aluminum production processes are treated with hydrofluoric acid to remove an oxide layer from the metal surface. A high integrity oxide film can subsequently be re-grown to protect the surface and provide a good foundation for the application of coatings and lacquers. If, however, the initial cleaning steps are not adequately performed and residual unwanted materials and contaminants remain on the surface of the metal substrate, the success of subsequent treatment and coating steps can be compromised.

Prior to the development of the method disclosed herein, the inventors have previously addressed the problem of reducing water consumption in a domestic or industrial cleaning method. WO2007/128962 discloses in its broadest aspect a method and formulation for cleaning a soiled substrate, the method comprising the treatment of the moistened substrate with a formulation comprising a multiplicity of polymeric particles, wherein the formulation is free of organic solvents. Cleaning of non-textile substrates is mentioned by one reference to plastics, leather, paper, cardboard, metal, glass or wood. Disclosed polymeric particles are particles of polyamides (including nylon), polyesters, polyalkenes, polyurethanes or their copolymers.

The above-mentioned prior art method has been successful in providing an efficient means of textile cleaning and stain removal while achieving significantly reduced water consumption in domestic and industrial laundry processes. The method of WO2007/128962 is not therefore specifically directed to the cleaning of metal substrates.

The present disclosure seeks to provide methods of cleaning a metal substrate which can ameliorate or overcome one or more of the above-noted problems associated with the prior art. Particularly, there is desired a method which can provide an improved means for removing unwanted materials and contaminants from the surface of a metal substrate. Furthermore, there is desired such a method for cleaning a metal substrate whereby the volume of polluting and hazardous effluent produced can be reduced. Also, there is desired a method of cleaning the surface of a metal substrate in which the consumption of water can be reduced with respect to comparable methods of the prior art. Also, there is desired a cleaning liquor suited to cleaning the surface of a metal substrate which can be used in said method.

### BRIEF SUMMARY OF THE DISCLOSURE

In embodiments of the present invention there is provided a method of cleaning a metal substrate. The method can comprise exposing the metal substrate to a body of cleaning liquor comprising a cleaning formulation and a multiplicity of solid particles. The method can further comprise causing the solid particles and the metal substrate to enter into contacting relative movement.

In some embodiments there is provided a method of cleaning a metal substrate, the method comprising exposing the metal substrate to a body of cleaning liquor comprising a cleaning formulation and a multiplicity of solid particles wherein the method further comprises causing the solid particles and the metal substrate to enter into contacting relative movement; wherein
i) the cleaning formulation comprises at least one acid which has a pKa greater than about −1.7; and/or
ii) the cleaning formulation comprises at least one base which has a pKb greater than about −1.7; and
the length of the particles is from about 0.5 mm to about 6 mm.

In some embodiments there is provided a cleaning liquor for cleaning a metal substrate. The cleaning liquor can comprise a cleaning formulation and a multiplicity of solid particles.

In some embodiments there is provided cleaning liquor for cleaning a metal substrate comprising a cleaning formulation and a multiplicity of solid particles wherein the cleaning formulation comprises an acid selected from citric acid, gluconic acid, adipic acid, acetic acid, lactic acid, glycolic acid, oxalic acid, formic acid or the alkali metal salts thereof and wherein the length of the particles is from about 0.5 mm to about 6 mm.

In some embodiments there is provided a cleaning liquor for cleaning a metal substrate comprising a cleaning formulation and a multiplicity of solid particles wherein the cleaning formulation comprises a citrate containing salt and wherein the length of the particles is from about 0.5 mm to about 6 mm.

Thus, in embodiments, the method of the invention can provide an improved cleaning effect compared to conventional metal substrate cleaning methods. A cleaning effect can also be achieved without requiring the use of highly aggressive conditions and/or using toxic chemicals.

In some embodiments, the cleaning formulation can comprise a solvent.

In some embodiments, the cleaning formulation can comprise at least one surfactant.

In some embodiments, the at least one surfactant can be a non-ionic surfactant.

In some embodiments, the cleaning formulation can comprise at least one acid.

In some embodiments, the at least one acid can have a pKa greater than about −1.7. In further embodiments, the at least one acid can have a pKa between about −1.7 and about 15.7.

In some embodiments, the at least one acid is an organic acid.

In some embodiments, the cleaning formulation can comprise at least one base.

In some embodiments, the at least one base can have a pKb greater than about −1.7. In further embodiments, the at least one base can have a pKb between about −1.7 and about 15.7.

In some embodiments, the cleaning formulation can comprise a compound with at least one carboxylic acid moiety.

In some embodiments, the cleaning formulation can comprise a compound with two or more carboxylic acid moieties.

In some embodiments, the cleaning formulation can comprise a compound containing at least one citrate moiety.

In some embodiments, the cleaning formulation can comprise at least one metal chelating agent.

In some embodiments, the cleaning formulation can be aqueous.

In some embodiments, the cleaning formulation can have a pH between about 1 and about 13.

In some embodiments, the cleaning formulation can have a pH greater than about 7.

In some embodiments, the cleaning formulation can have a pH of about 8.

In some embodiments, at least some of the solid particles can be buoyant in the cleaning formulation.

In some embodiments, the solid particles can have an average density of less than about 1.

In some embodiments, the solid particles can be in the form of beads.

In some embodiments, the method can comprise moving the metal substrate such that its surface is brought into contact with the solid particles.

In some embodiments, the method can comprise rotating, oscillating or reciprocating the metal substrate within the cleaning liquor.

In some embodiments, the method can comprise scouring the surface of the metal substrate with the solid particles.

In some embodiments, the method can comprise agitating the solid particles within the cleaning liquor.

In some embodiments, the method can be carried out using a fluidized bed containing the cleaning liquor.

In some embodiments, the multiplicity of solid particles can comprise a multiplicity of polymeric particles. In other embodiments the multiplicity of solid particles can consist of a multiplicity of polymeric particles.

In other embodiments, the multiplicity of solid particles can comprise a multiplicity of non-polymeric particles. In further embodiments, the multiplicity of solid particles can consist of a multiplicity of non-polymeric particles.

In some embodiments, the multiplicity of solid particles can comprise a mixture of a multiplicity of polymeric particles and a multiplicity of non-polymeric particles. In other embodiments the multiplicity of solid particles can consist of a mixture of a multiplicity of polymeric particles and a multiplicity of non-polymeric particles.

In some embodiments, the polymeric particles can comprise particles of one or more polar polymers. By polar we preferably mean that the polymer has carbon atoms bonded to one or more electronegative atoms, preferably selected from a halogen, oxygen, sulfur and nitrogen atoms.

In some embodiments, the polymeric particles can comprise particles of one or more non-polar polymers. By non-polar we preferably mean that the polymer has no carbon atoms bonded to one or one or more electronegative atoms, preferably selected from a halogen, oxygen, sulfur and nitrogen atoms.

In some embodiments, the polymeric particles can comprise particles of one or more polar polymers and particles of one or more non-polar polymers.

In some embodiments, the polymeric particles can comprise particles selected from particles of polyalkenes, polyamides, polyesters, polysiloxanes, polyurethanes or copolymers thereof.

In some embodiments, the polymeric particles can comprise particles selected from particles of polyalkenes or copolymers thereof.

In some embodiments, the polymeric particles can comprise particles of polypropylene.

In some embodiments, the polymeric particles can comprise particles selected from polyamide, polyester or copolymers thereof.

In some embodiments, the polyester particles can comprise particles of polyethylene terephthalate or polybutylene terephthalate.

In some embodiments, the polyamide particles can comprise particles of nylon.

In some embodiments, the polyamide particles can comprise Nylon 6 or Nylon 6,6.

In some embodiments, the non-polymeric particles can comprise particles of ceramic material, refractory material, igneous, sedimentary, metamorphic minerals or composites.

In some embodiments, the polymeric or non-polymeric particles can comprise beads.

In some embodiments, the polymeric particles can comprise particles selected from particles of linear, branched or cross-linked polymers.

In some embodiments, the polymeric particles can comprise foamed polymers.

In some embodiments, the polymeric particles can comprise unfoamed polymers.

In some embodiments, the solid particles can be of hollow and/or porous construction.

In some embodiments, the polymeric particles can have an average density of from about 0.5 to about 3.5 g/cm³.

In some embodiments, the non-polymeric particles can have an average density of from about 3.5 to about 12.0 g/cm³.

In some embodiments, the polymeric or non-polymeric particles can have an average volume in the range of about 5 to about 275 mm³.

In some embodiments, the solid particles can be reused one or more times for cleaning of metal substrates according to methods of embodiments of the invention.

In some embodiments the method can further comprise a step of recovering the multiplicity of solid particles after cleaning of the metal substrate. In further embodiments, the method can comprise separating the multiplicity of solid particles from the cleaning formulation.

In some embodiments, the cleaning formulation can comprise one or more components selected from the group consisting of: solvents, polymers, corrosion inhibitors, builders, metal chelating agents, surfactants, dispersants, acids, bases, anti-oxidants, reducing agents, oxidising agents and bleaches.

In some embodiments, the method can further comprise coating the metal substrate after cleaning the metal substrate. The coating can be a protective coating or lacquer.

In some embodiments, the metal substrate can comprise a transition metal.

In some embodiments, the metal substrate can comprise aluminum.

In some embodiments, the metal substrate can be a metal alloy.

In some embodiments, the metal substrate can comprise a metal sheet.

In some embodiments, the metal substrate can be a metal can such as an aluminum can.

In some embodiments the method can further comprise shaping or forming the metal substrate. Said shaping or forming can be prior to, or subsequent to, the cleaning steps of the method of the invention. The shaping or forming of the substrate can be to create a final desired form of an article, such as a can, or to form a precursor to said final desired form.

Further embodiments of the present invention can provide a method of treating a metal substrate. The method of treating can comprise:

a) cleaning the metal substrate in accordance with an embodiment of the invention hereinabove disclosed, and
b) removing at least a portion of an oxide layer from the surface of the cleaned substrate.

In some embodiments, step b) can comprise exposing the metal substrate to a treatment liquor comprising a treatment formulation and a multiplicity of solid particles.

In some embodiments, step b) can further comprise causing the solid particles and the metal substrate to enter into contacting relative movement.

In some embodiments, the treatment formulation can comprise one or more promoters selected from the group consisting of acids, bases and surfactants.

In some embodiments, the one or more promoters can comprise at least one metal chelating agent.

In some embodiments, the one or more promoters can comprise at least one carboxylic acid moiety.

In some embodiments, the one or more promoters can comprise two or more carboxylic acid moieties.

In some embodiments, the one or more promoters can comprise at least one citrate moiety.

In some embodiments, the one or more promoters can comprise at least one surfactant.

In some embodiments, the at least one surfactant can be a non-ionic surfactant.

In some embodiments, the solid particles can be in accordance with one or more of the embodiments hereinabove disclosed.

In some embodiments, the method of the treating the metal substrate can comprise passivating the metal substrate.

In some embodiments, the method of the treating the metal substrate can comprise inhibiting the re-growth of an oxide layer on the surface of the metal substrate.

Further embodiments of the invention disclose a metal substrate obtainable or obtained by the method of one or more embodiments of the invention hereinabove disclosed.

In some embodiments, the metal substrate can comprise an oxide layer with a thickness of less than 15 nm as measured by X-ray photoelectron spectroscopy.

In some embodiments, the metal substrate can comprise an oxide layer with a thickness of less than 10 nm as measured by X-ray photoelectron spectroscopy.

In some embodiments, the metal substrate can comprise an oxide layer with a thickness of less than 6 nm as measured by X-ray photoelectron spectroscopy.

In some embodiments, the metal substrate can comprise an oxide layer with a thickness of less than 5.4 nm as measured by X-ray photoelectron spectroscopy.

In some embodiments, the metal substrate can comprise an oxide layer with a thickness of less than 3.8 nm as measured by X-ray photoelectron spectroscopy.

### BRIEF DESCRIPTION OF THE DRAWING

FIG. 1 shows images of a pre-corroded mild steel substrate, a pre-corroded mild steel substrate treated in accordance with the invention and an un-corroded mild steel substrate.

### DETAILED DESCRIPTION

In certain embodiments, the method of the present invention involves cleaning a metal substrate by contacting the substrate with a cleaning formulation and a multiplicity of solid particles (also referred to herein as “a solid particulate material”). The metal substrate is contacted with the solid particulate material such that unwanted materials and contaminants including, but not limited to, fines (small particles of the metal) and smut, lubricants such as oils, lubricant residues, coolant residues, inorganic or organic salts, surfactants, biocides, emulsifiers and fungicides, are removed substantially or completely from the surface of the substrate.

The contact between the metal substrate and the solid particulate material surface can comprise a mechanical interaction and, in order to achieve this effect, contacting relative motion can be imparted between the metal substrate and the solid particulate material.

The cleaning liquor can comprise a cleaning formulation, which is typically a liquid phase, and the solid particulate material which can optionally be suspended in, or dispersed throughout, the cleaning formulation. In certain embodiments, the density of solid particulate material in the cleaning liquor (that is, the number of solid particles per unit volume of cleaning liquor) can be such that any given solid particle is in frequent, or substantially continuous, contact with the adjacent solid particles. Thus, in some embodiments, the cleaning liquor can be densely populated with the solid particulate material such that it is in the form of a slurry.

In further embodiments, a stream of cleaning liquor can be directed at the surface of the metal substrate. The method of the invention can therefore include the use of spraying apparatus such as pressurized nozzles or the like to direct the treatment liquor at the metal substrate surface.

In other embodiments, the metal substrate can be moved so that its surface is brought into contact with the solid particulate material. Such an interaction can be achieved by rotating or oscillating the metal substrate when suspended by a holding device at an appropriate position within a portion of the cleaning liquor containing the solid particulate material.

In examples, the formulation comprising the solid particulate material can be contained within a suitably sized treatment vessel or chamber. The metal substrate can be attached to a moveable arm or gripping device which is configured for rotation and/or oscillation and/or reciprocation. The speed, rate or extent of rotation and/or oscillation and/or reciprocation can be varied to increase or decrease the degree of mechanical interaction between the metal substrate surface and the solid particulate material.

In preferred embodiments the cleaning liquor contacts the metal surface at a relative velocity of at least 1 cm/s, more preferably at least 10 cm/s, even more preferably at least 50 cm/s and especially at least 100 cm/s. Preferably, the cleaning liquor contacts the metal surface at a relative velocity of no more than 100 m/s, more preferably no more than 50 m/s and especially no more than 10 m/s per second. In some embodiments it is preferred that the solid particles contact the metal substrate at a frequency of at least 1, more preferably at least 10, even more preferably at least 100 and especially at least 1000 particles per second per cm² of surface of the metal substrate. In some embodiments it is preferred that the solid particles contact the metal substrate at a frequency of no more than 1,000,000, more preferably no more than 100,000 and especially no more than 10,000 particles per second per cm² of surface of the metal substrate.

Alternatively or in addition, the solid particulate material can itself be stimulated to move such that the solid particles are constantly in motion within the cleaning liquor. In one suitable construction, the method can utilize an agitating device such as an aerator to bubble gas through the cleaning liquor at a rate sufficient to agitate the solid particulate material.

In certain embodiments, at least some of, and, in some further embodiments, substantially all of, the solid particles can be buoyant with respect to the cleaning liquor or formulation. Buoyant particles can be particularly suitable in embodiments in which an agitating device such as an aerator is used to bubble gas through the cleaning liquor at a rate sufficient to agitate the solid particulate material.

It should be noted that the term “cleaning” in relation to the metal substrate and in the context of the present disclosure contemplates the removal of contaminating material from the surface of the metal substrate. “Cleaning” of the metal substrate does not contemplate removal of material which is integral with the metal substrate surface, such as by being chemically bound to the metal of the metal substrate. For example, the removal or partial removal of an oxide layer formed at the surface of the metal substrate is not contemplated by the term “cleaning” of the metal substrate.

In some embodiments, the cleaning formulation can comprise at least one surfactant. The cleaning formulation can thus include one or more surfactants selected from non-ionic surfactants, anionic surfactants, cationic surfactants, ampholytic and/or zwitterionic surfactants, and semi-polar nonionic surfactants. It is believed that the presence of a surfactant in the cleaning formulation can facilitate an interaction with the surface of the metal substrate which can enhance the cleaning effect of the treatment. The surfactant can also reduce the surface tension of the cleaning formulation allowing better contact between the solid particles, the cleaning formulation and the metal substrate. The surfactant may also help to suspend small particles of surface contaminants which are removed from the surface of the metal substrate.

In some embodiments of the invention, the cleaning formulation can comprise a non-ionic surfactant. Examples of suitable non-ionic surfactants include, but are not limited to, Mulan 200S®, alcohol ethoxylates (e.g. C₁₄₋₁₅ alcohol 7 mole ethoxylate (Neodol 45-7)), polyoxyethylene glycol alkyl ethers (e.g. Brij®, octaethylene glycol monododecyl ether and pentaethylene glycol monododecyl ether), polyoxypropylene glycol alkyl ethers, glucoside alkyl ethers (e.g. decyl glucoside, lauryl glucoside, octyl glucoside), polyoxyethylene glycol octylphenol ethers, polyoxyethylene glycol alkylphenol ethers, glycerol alkyl esters (e.g. glycerol laurate), polyoxyethylene glycol sorbitan alkyl esters (e.g. polysorbate), sorbitan alkyl esters (e.g. spans), cocamide MEA, cocamide DEA, dodecyldimethylamine oxide, block copolymers of polyethylene glycol and polypropylene glycol (e.g. poloxamers), polyethoxylated tallow amine (POEA).

In some embodiments of the invention, the cleaning formulation can comprise a compound with at least one carboxylic acid moiety. In further embodiments, the cleaning formulation can comprise a compound with two or more carboxylic acid moieties, and, in some embodiments, at least three carboxylic acid moieties. In certain embodiments, the cleaning formulation can comprise at least one citrate moiety and can include, for example, citrate containing salts such as sodium citrate and trisodium citrate.

In further embodiments, the cleaning formulation can comprise one or more metal chelating agents. Examples of suitable chelating agents can include, but are not limited, citrates such as trisodium citrate and sodium citrate, phosphonates (e.g. Nitrilotrimethylenetris(phosphonic acid), ethylenediamine tetraacetic acid (EDTA), gluconates (e.g. sodium gluconate) and oxalate. In some embodiments the inclusion of one or more metal chelating agents in the cleaning formulation is believed to promote a surface interaction with the metal substrate which can facilitate the removal of unwanted materials from the substrate surface.

In certain embodiments of the invention the cleaning formulation can comprise at least one acid. In some embodiments, the cleaning formulation can include acids selected from, but not limited to, carboxylic acids such as citric acid, gluconic acid, adipic acid, acetic acid, lactic acid, glycolic acid, oxalic acid and formic acid, polycarboxylates such as succinic acid, oxydisuccinic acid, carboxymethyloxysuccinic acid, polymaleic acid, mellitic acid and benzene 1,3,5-tricarboxylic acid, phosphates such as sodium hydrogen phosphate, sodium dihydrogen phosphate and zinc hydrogen phosphate, sulphate and sulphite containing compounds such as sodium bisulphate, sodium bisulphite, iron (II) sulphate and iron (III) sulphate, sulphonic acids such as methane sulphonic acid, phenol sulphonic acid, toluene sulphonic acid, acrylamido-2-methylpropanesulphonic acid and polyvinylsulphonic acid, polyacetic acids such as ethylenediamine tetraacetic acid and nitrilotriacetic acid, weak acids such as phosphoric acid, carbonic acid and hydrogen peroxide, and others including ascorbic acid and acidic ion exchange resins based on sulphonic acids such as acrylamido-2-methylpropanesulphonic acid and chelating resins based on dicarboxylic acids such as iminodiacetic acid.

In some embodiments of the invention the cleaning formulation can comprise at least one base. In some embodiments, the cleaning formulation can include bases selected from, but not limited to, one or more alkali metal containing compounds and/or salts thereof such as sodium polyacrylate, sodium acrylamido-2-methylpropanesulphonate, sodium polyvinylsulphonate, sodium carbonate, sodium hydrogen carbonate, sodium citrate, trisodium citrate, sodium oxalate, sodium phosphate, sodium phenol sulphonate, sodium toluene sulphonate, sodium methane sulphonate, sodium lactate, sodium gluconate, sodium glycolate and sodium formate and others including zinc phosphate, poly (acrylamido-N-propyltrimethylammonium chloride), polyethylene amine, zinc dithiophosphate, benzalkonium chloride, alkylaminophosphates plus the alkali metal salts of polyphosphates, ammonium salts of polyphosphates and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, alkali metal salts of polyacetic acids, ammonium salts of polyacetic acids and substituted ammonium salts of polyacetic acids such as ethylendiamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid and soluble salts thereof and basic ion exchange resins including those based on quaternary amino groups such as trimethylammonium groups, for example, poly (acrylamido-N-propyltrimethylammonium chloride).

Thus in some embodiments of the invention the cleaning of the metal substrate can be performed using bases as opposed to the acidic reagents typically employed in methods of the prior art.

In some embodiments of the invention the acids and/or bases when present in the cleaning formulation can have dissociation or ionization constants within a specified range. Thus the acids can have particular pKa values in a dilute aqueous solution, wherein pKa is defined as the negative of the logarithm of the equilibrium constant Ka for the reaction:

HA [symbol] H⁺+A⁻

i.e., Ka=[H⁺][A⁻]/[HA]

where [H⁺], etc. represent the concentrations of the respective species in mol/L. It follows that pKa=pH+log [HA]−log [A⁻], so a solution with 50% dissociation has pH equal to the pKa of the acid.

In some embodiments of the invention the acids can have pKa values greater than about −1.7. In further embodiments, the acids can have a pKa between about −1.7 and about 15.7 (the pKa of water). In still further embodiments, the acids can have pKa values greater than about 1. In certain embodiments, the acids can have pKa values between about 1 and about 15.7. In still further embodiments, the acids can have pKa values between about 1 and about 12. In embodiments of the invention containing polyprotic acids, each pKa value may be in accordance with the ranges specified above (for example, the acidic compound can contain more than one pKa value each which is greater than about −1.7). Thus in some embodiments of the invention, the acids of the cleaning formulation are weaker than strong acids with pKa values of less than −1.7 (e.g. sulphuric acid or hydrochloric acid) that are commonly employed in methods of the prior art.

In some embodiments it is preferred that no acid present in the cleaning formulation has a pKa of less than or equal to about −1.7, more preferably no acids presents in the cleaning formulation have a pKa outside about −1.7 to about 15.7, even more preferably no acids presents in the cleaning formulation have a pKa outside about 1 to about 12. In some embodiments the cleaning formulation does not comprise a mineral acid (examples of which include sulphuric acid, hydrochloric acid, hydrofluoric acid, hydriodic acid, nitric acid and phosphonic acid)

As noted above, bases included in some embodiments of the invention can have ionization constants within a specified range. Thus the bases can have particular pKb values in a dilute aqueous solution, wherein the logarithm of the ionisation constant, pKb, is derived from the reaction: B+H₂O [symbol] BH⁺+OH⁻. This is related to Ka by:

pKa+pKb=pK_{water}=14.00 (at 25° C.).

In some embodiments of the invention bases included in the cleaning formulation can have pKb values greater than about −1.7. In further embodiments, the bases can have pKb between about −1.7 and about 15.7 (the pKb of water). In still further embodiments, the bases can have pKb values greater than about 1. In certain embodiments, the bases can have pKb values between about 1 and about 15.7. In still further embodiments, the bases can have pKb values between about 1 and about 12.

In some embodiments it is preferred that no base present in the cleaning formulation has a pKb of less than or equal to about −1.7, more preferably no bases presents in the cleaning formulation have a pKb outside about −1.7 to about 15.7, even more preferably no bases presents in the cleaning formulation have a pKa outside about 1 to about 12.

The solid particulate material for use in embodiments of the method of the invention can comprise a multiplicity of polymeric particles or a multiplicity of non-polymeric particles. In some embodiments, the solid particulate material can comprise a multiplicity of polymeric particles. Alternatively, the solid particulate material can comprise a mixture of polymeric particles and non-polymeric particles. In such embodiments, the mixture can contain predominantly polymeric particles. In other embodiments, the solid particulate material can comprise a multiplicity of non-polymeric particles. Thus the solid particulate material in embodiments of the invention can comprise exclusively polymeric particles, exclusively non-polymeric particles or mixtures of polymeric and non-polymeric particles.

The polymeric or non-polymeric particles can be of such a shape and size as to allow for intimate contact with the surface of the metal substrate. A variety of shapes of particles can be used, such as cylindrical, spherical or cuboid; appropriate cross-sectional shapes can be employed including, for example, annular ring, dog-bone and circular. The particles can have smooth or irregular surface structures. The particles can be of solid, porous or hollow structure or construction. For example, in embodiments wherein the solid particulate material is buoyant, the solid particulate material can conveniently comprise polymeric or non-polymeric particles which are hollow or porous to confer buoyant properties to said particulate material. In some embodiments, the polymeric or non-polymeric particles can comprise cylindrical or spherical beads.

In some embodiments the polymeric particles can be of such a size as to have an average mass of about 0.001 mg to about 250 g. In further embodiments the polymeric particles can be of such a size as to have an average mass of about 0.001 mg to about 10 g. In still further embodiments the polymeric particles can be of such a size as to have an average mass of about 0.001 mg to about 1 g. In yet further embodiments the polymeric particles can be of such a size as to have an average mass of about 1 mg to about 100 mg. In still further embodiments the polymeric particles can be of such a size as to have an average mass of about 5 mg to about 100 mg.

In some embodiments the non-polymeric particles can be of such a size as to have an average mass of about 0.001 mg to about 250 g. In further embodiments the non-polymeric particles can be of such a size as to have an average mass of about 0.001 mg to about 10 g. In still further embodiments the non-polymeric particles can be of such a size as to have an average mass of about 0.001 mg to about 1 g. In yet further embodiments the non-polymeric particles can be of such a size as to have an average mass of about 1 mg to about 100 mg. In still further embodiments the non-polymeric particles can be of such a size as to have an average mass of about 5 mg to about 100 mg.

In embodiments of the invention, the length of the particle can be from about 1 micron (1 micrometer) to about 500 mm. In other embodiments the length of the particle can be from about 0.1 mm to about 500 mm. In further embodiments the length of the particle can be from about 0.5 mm to about 25 mm. In still further embodiments the length of the particle can be from about 0.5 mm to about 6 mm. In still further embodiments the length of the particle can be from about 1.5 mm to about 4.5 mm. In yet further embodiments the length of the particle can be from about 2.0 mm to about 3 mm. The length of the particle is preferably defined as the maximal linear spacing between two points on the surface of the particle.

In embodiments the polymeric particles can comprise particles of polar polymers. In other embodiments, the polymeric particles can comprise particles of non-polar polymers. Mixtures of particles comprising polar polymers and particles comprising non-polar particles can be used in embodiments of the invention. It is believed that the inclusion of particles of non-polar polymers in the method of the invention, for example polypropylene, can enhance the cleaning of unwanted materials such as oils and contaminants from the surface of the metal.

The polymeric particles can comprise polyalkenes such as polyethylene and polypropylene, polyamides, polyesters, polysiloxanes or polyurethanes. Furthermore, said polymers can be linear, branched or crosslinked. In certain embodiments, said polymeric particles can comprise polyamide or polyester particles, such as particles of nylon, polyethylene terephthalate or polybutylene terephthalate. In embodiments these particles can be in the form of beads. In embodiments of the invention, the polymeric particles can comprise copolymers of the above-polymeric materials. The properties of the polymeric materials can be tailored to specific requirements by the inclusion of monomeric units which confer particular properties on the copolymer.

Various nylon homo- or co-polymers can be used in different embodiments of the invention including, but not limited to, Nylon 6 and Nylon 6,6. In an embodiment, the nylon can comprise Nylon 6,6 copolymer, preferably having a molecular weight in the region of from 5000 to 30000 Daltons, such as from about 10000 to about 20000 Daltons or such as from about 15000 to about 16000 Daltons.

Useful polyesters for forming particles in accordance with embodiments of the invention can have a molecular weight corresponding to an intrinsic viscosity measurement in the range of from about 0.3 to about 1.5 dl/g, as measured by a solution technique such as ASTM D-4603.

In some embodiments, the polymeric or non-polymeric particles can have an average density of less than about 1. In certain embodiments, the polymeric or non-polymeric particles can have an average density of about 0.5 to about 0.99 g/cm³.

In other embodiments, the polymeric or non-polymeric particles can have an average density in the range of about 0.5 to about 20 g/cm³. In some embodiments the polymeric particles, or the non-polymeric particles, can have an average density in the range of about 0.5 to about 12 g/cm³. In still other embodiments the polymeric particles, or the non-polymeric particles, can have an average density in the range of about 0.5 to about 3.5 g/cm³. In still further embodiments the polymeric particles or the non-polymeric particles can have an average density in the range of about 0.5 to about 2.5 g/cm³.

In some embodiments, the polymeric particles or the non-polymeric particles can have an average volume of about 5 to about 275 mm³. In further embodiments, the polymeric or non-polymeric particles can have an average volume of about 8 to about 140 mm³. In still further embodiments, the polymeric or non-polymeric particles can have an average volume of about 10 to about 120 mm³.

In some embodiments, the polymeric particles can have an average density in the range of from about 0.5 to about 3.5 g/cm³ and an average volume of about 5 to about 275 mm³.

In some embodiments, the polymeric particles can have an average density in the range of from about 0.5 to about 2.5 g/cm³. In further embodiments the polymeric particles can have an average density in the range of from about 0.55 to about 2.0 g/cm³. In still further embodiments the polymeric particles can have an average density in the range of from about 0.6 to about 1.9 &m°.

In certain embodiments, the non-polymeric particles can have an average density greater than the polymeric particles. Thus, in some embodiments, the non-polymeric particles can have an average density in the range of about 0.5 to about 2.0 g/cm³. In further embodiments, the non-polymeric particles can have an average density in the range of about 3.5 to about 12.0 g/cm³. In still further embodiments, the non-polymeric particles can have an average density in the range of about 5.0 to about 10.0 g/cm³. In yet further embodiments, the non-polymeric particles can have an average density in the range of about 6.0 to about 9.0 g/cm³.

In some embodiments, the solid particulate material can comprise non-polymeric particles. The non-polymeric particles can comprise particles selected from ceramic material, refractory material, igneous, sedimentary, metamorphic minerals and composites. Suitable ceramics can include, but are not limited to, alumina, zirconia, tungsten carbide, silicon carbide and silicon nitride.

In certain embodiments, the method of the invention can comprise scouring the surface of the metal substrate with the multiplicity of solid particles. Thus in some embodiments, the solid particles can be abrasive or have some abrasive qualities.

In certain embodiments of the invention, the cleaning formulation can be aqueous. Thus in some embodiments, the cleaning formulation can comprise or consist of water. However, as a more effective cleaning action can be provided due to the enhanced interaction between the metal substrate surface and the solid particulate material, the quantity of any water used in some advantageous embodiments can be significantly reduced with respect to comparable aqueous-based cleaning methods of the prior art.

In some embodiments the cleaning formulation can further comprise one or more solvents. Suitable solvents that can be contained in the treatment formulation can include, but are not limited to, water, polar solvents and non-polar solvents.

In some embodiments, water is the preferred solvent. Other suitable solvents can include alcohols (especially ethanol and isopropanol), glycols and glycol mono and di-ethers, cyclic amides (e.g. pyrrolidone and methyl pyrrolidone). In some embodiments the amount of solvents other than water is less than 10 wt %, more preferably less than 5 wt %, especially less than 2 wt % and most especially less than 0.5 wt % of the treatment formulation. In some embodiments the only solvent present in the treatment formulation is water.

In some embodiments, the cleaning formulation of the invention can comprise one or more components selected from the group consisting of: solvents, polymers, corrosion inhibitors, surfactants, chelating agents, anti-oxidants, builders, dispersants, acids, bases, reducing agents, oxidising agents and bleaches.

Suitable solvents that can be contained in the cleaning formulation can include, but are not limited to, water, polar solvents and non-polar solvents.

Suitable polymers that can be contained in the cleaning formulation can include, but are not limited to, polyacrylates and polyethylene glycol.

Suitable corrosion inhibitors that can be contained in the cleaning formulation can include, but are not limited to, benzotriazole, zinc phosphate, zinc dithiophosphate, benzalkonium chloride and alkylaminophosphates.

Suitable anti-oxidants that can be contained in the cleaning formulation can include, but are not limited to, sodium bisulphite and ascorbic acid.

Suitable builders that can be contained in the cleaning formulation can include, but are not limited to, alkali metal salts of polyphosphonates, ammonium salts of polyphosphonates, alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyl-oxysuccinic acid, alkali metal salts of polyacetic acids, ammonium salts of polyacetic acids, substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid and soluble salts thereof.

Optionally, the cleaning formulation can also contain dispersants. Suitable water-soluble organic materials for use as dispersants can be the homo- or co-polymeric polycarboxylic acids or their salts, in which the polycarboxylic acid can comprise at least two carboxyl radicals separated from each other by not more than two carbon atoms. Suitable reducing agents that can be contained in the cleaning formulation include, but are not limited to, iron (II) sulphate and oxalic acid.

The cleaning formulation can include one or more bleaches and/or oxidizing agents. Examples of such bleaches and/or oxidizing agents can include, but are not limited to, ozone, oxygen, peroxygen compounds, including hydrogen peroxide, inorganic peroxy salts, such as perborate, percarbonate, perphosphate, persilicate, and mono persulphate salts (e.g. sodium perborate tetrahydrate and sodium percarbonate), sodium hypochlorite, chromic acid, nitric acid and organic peroxy acids such as peracetic acid, monoperoxyphthalic acid, diperoxydodecanedioic acid, N,N′-terephthaloyl-di(6-aminoperoxycaproic acid), N,N′-phthaloylaminoperoxycaproic acid and amidoperoxyacid. The bleaches and/or oxidizing agents can be activated by a chemical activation agent.

Activating agents can include, but are not limited to, carboxylic acid esters such as tetraacetylethylenediamine and sodium nonanoyloxybenzene sulphonate. Alternatively, the bleach compounds and/or oxidizing agents can be activated by heating the formulation.

In certain embodiments, the cleaning formulation of the invention can have a pH greater than 7. In some embodiments the cleaning formulation can have a pH less than 13 and in further embodiments, the cleaning formulation can have a pH not less than 1. In some embodiments the cleaning formulation can have a pH between 1 and 13. In other embodiments, the treatment formulation can have a pH from about 2 to about 12. The cleaning formulation can therefore have pH values of at or about 2, 3, 4, 5, 6, 7, 8, 9, 10, 11 or 12. In certain embodiments, the cleaning formulation can have a pH around 8 and specifically the cleaning formulation can have pH between 8 and 9. Thus in some embodiments of the invention, cleaning of the metal substrate can be performed in mild conditions as opposed to the harsh acidic conditions commonly employed by comparable methods of the prior art. By mild we preferably mean the cleaning formulation has a pH of at least 3, more preferably at least 4, especially at least 5 and/or less than 14, preferably less than 12, more preferably less than 11, especially less than 10 and most especially less than 9.

In some embodiments the metal substrate is exposed to the cleaning liquor for at least 1 second, at least 10 seconds, at least 20 seconds or at least 30 seconds. In some embodiments the metal substrate is exposed to the cleaning liquor for no more than 2 hours, no more than 1 hour, no more than 30 minutes, 5 minutes, no more than 4 minutes, no more than 3 minutes or no more than 2 minutes.

The method of the invention can further comprise coating the surface of the metal substrate. In certain embodiments, an additional treatment can be performed to apply one or more coatings after the step of cleaning the surface of the metal substrate.

The method can include further additional steps in combination with the cleaning step to treat the metal substrate. Thus, in some embodiments there is disclosed a method of treating a metal substrate. The method of treating can comprise:
a) cleaning the metal substrate in accordance with one or more embodiments of the invention disclosed herein, and subsequently
b) removing at least a portion of an oxide layer from the surface of the cleaned substrate.

The cleaning step in step a) can comprise any cleaning method according to any embodiment disclosed herein.

In some embodiments, step b) can comprise exposing the metal substrate to a liquor comprising a treatment formulation and a multiplicity of solid particles. Step b) can further comprise causing the solid particles and the metal substrate to enter into contacting relative movement. In certain embodiments, the treatment formulation can comprise one or more promoters selected from the group consisting of acids, bases and surfactants. In further embodiments, the one or more promoters of the treatment formulation can comprise at least one metal chelating agent. In yet further embodiments, the one or more promoters can comprise at least one carboxylic acid moiety. In still further embodiments, the one or more promoters can comprise two or more carboxylic acid moieties. In yet further embodiments the treatment formulation can comprise at least one citrate moiety. In some embodiments, the treatment formulation can comprise at least one surfactant. In an embodiment, the at least one surfactant can be a non-ionic surfactant. The treatment formulation can comprise a multiplicity of solid particles such as outlined herein in relation to the embodiments of cleaning method of the invention. In some embodiments, the method of treating the metal substrate can comprise a step of passivating the metal substrate. In embodiments of the invention, passivation can be defined as treatment of the metal substrate in order to reduce the reactivity of the metal surface.

In these embodiments of the invention, the treatment method can provide an oxide layer on the surface of the metal with substantially reduced thickness compared to control samples not treated by the method of the present invention. Thus in some embodiments, the metal substrate as treated by the method of the invention can comprise an oxide layer with a thickness of less than 15 nm as measured by X-ray photoelectron spectroscopy (XPS). In further embodiments, the metal substrate as treated by a method of the invention can comprise an oxide layer with a thickness of less than 10 nm as measured by XPS. In still further embodiments, the metal substrate as treated by a method of the invention can comprise an oxide layer with a thickness of less than 6 nm as measured by XPS. In yet further embodiments, the metal substrate as treated by a method of the invention can comprise an oxide layer with a thickness of less than 5.4 nm as measured by XPS. In still further embodiments, the metal substrate can comprise an oxide layer with a thickness of less than 4.1 nm as measured by XPS. In yet still further embodiments, the metal substrate can comprise an oxide layer with a thickness of less than 3.8 nm as measured by X-ray photoelectron spectroscopy

In some embodiments the method can comprise continuing step b) until the oxide layer has a thickness of less than 15 nm as measured by X-ray photoelectron spectroscopy (XPS) such as less than 10 nm, or less than 6 nm, or less than 5.4 nm and in particular less than 4.1 nm, such as less than 3.8 nm.

Thus the treatment by the method of the invention can facilitate the removal or partial removal of an oxide layer from the surface of the metal substrate. In embodiments, the oxide layer can subsequently reform so that the oxide layer can be substantially uniform. As such, damaged, discontinuous or non-uniform oxide layers can be replaced by the method of the invention, and the metal surface homogeneity can be improved. The uniform oxide layer can provide an improved foundation for the application of one or more coatings, or lacquers to the metal substrate or for carrying out subsequent finishing steps on the metal substrate.

In certain embodiments, the treatment by the method of the invention can inhibit the re-growth of an oxide layer on the surface of the metal. Thus in some embodiments the treatment of the metal surface can facilitate the removal or partial removal of an oxide layer and can also restrict the re-growth or reformation of the oxide layer following exposure of the metal substrate to air.

In some embodiments of the invention, the solid particulate material can be retained for more than one cleaning or further treatment of the metal substrate. Thus in some embodiments of the invention, the solid particulate material, and hence the polymeric or non-polymeric particles comprising solid particulate material, can be reused one or more times with a plurality of metal substrates. In some embodiments the method can further comprise a step of recovering the multiplicity of solid particles after cleaning of the metal substrate. In further embodiments, the method can further comprise separating the multiplicity of solid particles from the cleaning formulation.

The method of the invention can be performed with a variety of different metal substrates. In certain embodiments, the metal substrate can comprise a transition metal. In some embodiments, the metal substrate can be aluminum or can comprise aluminum. In some embodiments, the metal substrate can be or can comprise iron. In further embodiments, the metal substrate can be a metal alloy including, but not limited to, alloys of transition metals (for example, alloys of iron such as steel). In other embodiments, the substrate can be a metal-containing composite. Other suitable metal substrates include tantalum, chromium, nickel, uranium, titanium, vanadium, chromium, zinc, tin, lead, copper, cadmium and magnesium. Some relatively inert metals such as silver, gold, palladium and platinum are also suitable. Other suitable metal substrates include rare earth metals such as scandium, yttrium, lanthanum, cerium, praseodymium, neodymium, promethium, samarium, europium, gadolinium, terbium, dysprosium, holmium, erbium, thulium, ytterbium and lutetium. Potentially then, the present invention can have application in the recycling of metals.

In some embodiments it is preferred that the weight ratio of the cleaning formulation to the multiplicity of solid particles is no more than 20:1, more preferably no more than 10:1, even more preferably no more than 5:1, especially no more than 3:1, even more especially no more than 2:1 and most especially no more than 1:1. In some embodiments it is preferred that the weight ratio of the cleaning formulation to the multiplicity of solid particles is less than 1:2, more preferably less than 1:3, even more preferably less than 1:5, yet more preferably less than 1:10, especially less than 1:15. These embodiments use desirably small amounts of cleaning formulations. In some embodiments it is preferred that the weight ratio of the cleaning formulation to the multiplicity of solid particles is no less than 1:100, more preferably no less than 1:50 and especially no less than 1:25. In some embodiments the weight ratio of the cleaning formulation to the multiplicity of solid particles is not 14:20. In some embodiments the weight ratio of the cleaning formulation to the multiplicity of solid particles is not from 1:2 to 1:1.

In certain embodiments the metal substrate can be a food or beverage container. In further embodiments the metal substrate can be a metal can for food or beverage use, such as an aluminum can. In other embodiments the metal substrate can be a metal sheet. The metal substrate can, in principle, be in any desired form in accordance with its ultimate intended use. For example, the metal substrate can be in the form of an as-manufactured metal sheet, sheet metal which has been subjected to post-manufacture treatment steps, metal which has been subjected to cutting or forming steps to achieve a desired shape, a metal blank intended for subsequent forming into a final product, or a substantially finished product in which shaping or forming steps have been substantially completed. An example of a substantially finished product is an open-ended container or can such as for food or beverage use.

The invention will now be further illustrated, though without in any way limiting the scope thereof, by reference to the following examples.

### EXAMPLES

### Experiment 1

### Aluminum Oxide Removal and Cleaning Efficiency

Experiments were undertaken to investigate the cleaning efficiency of formulations prepared in accordance with the method of the invention for aluminum cans. Experiments were also conducted to assess the extent to which the method of the invention could remove an aluminum oxide layer from a metal substrate which, in this case, was an aluminum can.

The ingredients of the treatment (cleaning) formulation for each experiment, together with sample labels, are listed in Table 1. The surfactant, Mulan 200S™, was a non-ionic surfactant supplied by Christeyns, Bradford, UK and the citrate component consisted of trisodium citrate dihydrate supplied by VWR, Loughborough, UK. The polymeric particles were Nylon 6,6 grade Technyl™ XA1493 supplied by Solvay, Lyon, France and polypropylene grade 575P Natural, as supplied by Resinex UK Ltd., High Wycombe, UK in the form of beads. The total mass of the polymeric particles used in the apparatus was 2000 g. Uncoated aluminum metal cans grade AUSC60ML63X15 were supplied by Invopak UK Ltd. Hyde, Cheshiro, UK.

TABLE 1
Sample details and formulation components

| Sample | Formulation components/treatment |
|---|---|
| Can 1 | Control Can - No Treatment |
| Can 2 | Water Only 1000 g |
| Can 3 | Water 1000 g + |
| | Citrate 200 g + |
| | Non-ionic Surfactant 200 g |
| Can 4 | Nylon polymeric particles 2000 g + |
| | Water 1000 g |
| Can 5 | Nylon polymeric particles 2000 g + |
| | Water 1000 g + |
| | Citrate 200 g + |
| | Non-ionic Surfactant 200 g |
| Can 6 | Polypropylene polymeric particles 2000 g + |
| | Water 1000 g |
| Can 7 | Polypropylene polymeric particles 2000 g + |
| | Water 1000 g + |
| | Citrate 200 g + |
| | Non-ionic Surfactant 200 g |

In order to carry out the experiments, the cleaning liquor was added to a vessel. The cleaning liquor consisted of the polymeric particles (of total mass 2000 g) and Milli-Q™ (Type 1 ISO 3696) water (1000 g) and the further formulation components as shown in Table 1. Aluminum cans were fixed to a metal rod which was attached to an agitator. Each can was inserted into the vessel containing the cleaning liquor. The cans were then rotated at approximately 500 rpm in the tub for a period of 30 minutes at a temperature of approximately 22° C., ensuring contact between the can and the cleaning liquor. After treatment, the cans were washed with Milli-Q™ water and isopropanol and subjected to X-ray photoelectron spectroscopy (XPS) analysis.

The method for XPS analysis was as follows: The samples were immobilised onto carbon tape for analysis with a Thermo EscaLab 250, using an Al kα monochromated radiation source. A spot size of 500 μm was used for the analysis. An overall survey scan (1250-0 eV) using a pass energy of 150 eV, dwell time of 50 ms and step size of 1 eV was taken initially, followed by detailed scans of the main peaks for the elements identified, using a pass energy of 20 eV, dwell time of 50 ms and step size of 0.1 eV. The measured data was fitted using Casa X-ray photoelectron spectroscopy—XPS (Casa Software Ltd, UK), using relative sensitivity factors based upon the scheme where C1s=1, and adjusted to correct for any minor charging using the aliphatic carbon peak at 285 eV. Each sample was measured in 3 places. XPS spectra were obtained by irradiating a portion of the aluminum can surface with a beam of X-rays while simultaneously measuring the kinetic energy and number of electrons that escape from the top 1 to 10 nm of the material.

TABLE 2
XPS results for cleaning efficiency

| | | Aluminum | | |
|---|---|---|---|---|
| | | Metal | Carbon | Aluminum/ |
| | | Content | Content | Carbon |
| Sample | Treatment | (%) | (%) | Ratio |
| Can 1 | Control Can - No | 12.35 | 56.11 | 0.22 |
| | Treatment | | | |
| Can 2 | Water Only | 18.90 | 39.14 | 0.48 |
| Can 3 | Water + Citrate + non- | 16.86 | 33.17 | 0.51 |
| | ionic surfactant | | | |
| Can 4 | Nylon + Water | 20.29 | 37.23 | 0.54 |
| Can 5 | Nylon + Water + Citrate + | 31.38 | 27.96 | 1.12 |
| | non-ionic surfactant | | | |
| Can 6 | Polypropylene + Water | 23.49 | 33.23 | 0.71 |
| Can 7 | Polypropylene + Water + | 24.59 | 29.02 | 0.85 |
| | Citrate + non-ionic | | | |
| | surfactant | | | |

The data shown in Table 2 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 2 thus indicates that more aluminum is present on the can surface and that more carbon or contaminant residue has been removed. All of the cans treated with the polymeric particles (i.e. cans 4 to 7) show an increase in aluminum/carbon ratio compared to the controls (cans 1 to 3) demonstrating an improved cleaning efficiency. A considerable increase in cleaning performance is shown for cans 5 and 7 which each further include citrate and a non-ionic surfactant in the formulation. In addition, a significant enhancement in cleaning performance was noted for can 6 which comprised treatment with polypropylene polymeric particles and water only.

TABLE 3
XPS results for aluminum oxide removal

| | | | | Aluminum | Standard |
|---|---|---|---|---|---|
| | | | | Oxide | Deviation |
| | | Aluminum | Aluminum | layer | On Oxide/ |
| | | Oxide | Metal | Thickness | Metal |
| Sample | Treatment | Area (%) | Area (%) | (nm) | Area (%) |
| Can 1 | Control Can - | 91.9 | 8.1 | 7.90 | 1.3 |
| | No | | | | |
| | Treatment | | | | |
| Can 2 | Water Only | 95.4 | 4.6 | 9.51 | 3.1 |
| Can 3 | Water + | 96.7 | 3.3 | 10.45 | 2.1 |
| | Citrate + | | | | |
| | non-ionic | | | | |
| | surfactant | | | | |
| Can 4 | Nylon + | 92.9 | 7.1 | 8.28 | 3.3 |
| | Water | | | | |
| Can 5 | Nylon + | 80.6 | 19.4 | 5.36 | 1.2 |
| | Water + | | | | |
| | Citrate + | | | | |
| | non-ionic | | | | |
| | surfactant | | | | |

The data shown in Table 3 illustrates the results of XPS analysis for the amount of aluminum oxide and aluminum metal on the can surface following the various treatments (note that verified data for can 6 and can 7 was obtained for cleaning efficiency only). The thickness of the aluminum oxide layer was also calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for can 5, treatment of the can with nylon beads, water, citrate and the non-ionic surfactant demonstrated a significant decrease in the aluminum oxide area (%) and a significant increase in the aluminum metal area (%) for the surface of the metal substrate compared to the controls (i.e. cans 1, 2 and 3) and compared to the treatment with nylon beads and water alone (can 4). Furthermore, an aluminum oxide layer of significantly reduced thickness was obtained for can 5 (5.36 nm) compared to the controls and when compared to the treatment with nylon beads and water.

### Experiment 2

### Aluminum Cleaning & Oxide Removal Using an Apparatus Fitted with Pumping Means

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated aluminum metal cans grade ALJSC60ML63X15 were supplied by Invopak UK Ltd. Hyde, Cheshire.

XPS analysis was carried out with an Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 4. Aluminum cans were fixed to a metal rod which was fixed by means of a clamp. Each can was inserted into the vessel containing the treatment liquor. The cans were then subjected to contact with the pumped liquor for a period of 30 minutes at a temperature of 22° C., ensuring contact between the can and the treatment liquor. After treatment, the cans were washed with Milli-Q™ water and isopropanol and subjected to XPS analysis.

TABLE 4
Sample Details and Formulation Components.

| Sample | Formulation components/treatment |
|---|---|
| Can 1 | Control Can - No Treatment |
| Can 2 | Can Treated With Water Only |
| Can 3 | Water 45 kg + Citrate 500 g + |
| | Non-ionic Surfactant 25 g |
| Can 4 | Water 45 kg + Citrate 500 g + |
| | Non-ionic Surfactant 25 g + |
| | Nylon polymeric particles 10 kg |

TABLE 5
XPS results for aluminum oxide removal

| | | | Alu- | | |
|---|---|---|---|---|---|
| | | | mi- | | |
| | | | num | Aluminum | |
| | | Aluminum | Metal | Oxide layer | Standard |
| Sam- | | Oxide | Area | Thickness | Deviation |
| ple | Treatment | Area (%) | (%) | (nm) | (%) |
| Can 1 | Control Can - | 97.70 | 2.31 | 11.49 +/− 0.47 | 0.39 |
| | No | | | | |
| | Treatment | | | | |
| Can 2 | Can Treated | 94.38 | 5.63 | 8.94 +/− 0.13 | 0.25 |
| | With Water | | | | |
| | Only | | | | |
| Can 3 | Water 45 kg + | 94.46 | 5.54 | 8.99 +/− 0.15 | 0.28 |
| | Citrate 500 g + | | | | |
| | Non-ionic | | | | |
| | Surfactant | | | | |
| | 25 g | | | | |
| Can 4 | Water 45 kg + | 69.76 | 30.24 | 4.03 +/− 0.02 | 0.17 |
| | Citrate 500 g + | | | | |
| | Non-ionic | | | | |
| | Surfactant | | | | |
| | 25 g + | | | | |
| | Nylon | | | | |
| | polymeric | | | | |
| | particles | | | | |
| | 10 kg | | | | |

The data shown in Table 5 illustrates the results of XPS analysis for the amount of aluminum oxide and aluminum metal on the can surface following the various treatments. The thickness of the aluminum oxide layer was calculated in accordance with the standard methods outlined in B. R. Strohmeier, Surf. Interface Anal. 1990, 15, 51 and T. A. Carlson, G. E. McGuire, J. Electron Spectrosc, Relat. Phenom, 1972/73; 1, 161. As shown by the results for can 4, treatment of the can with nylon beads, water, citrate and the non-ionic surfactant demonstrated a significant decrease in the aluminum oxide area (%) and a significant increase in the aluminum metal area (%) for the surface of the metal substrate compared to the controls (i.e. cans 1, 2 and 3). Furthermore, an aluminum oxide layer of significantly reduced thickness was obtained for can 4 (4.03 nm) compared to the controls and especially when compared to the treatment with citrate, Mulan™ and water alone. What is also significant is that the reduced thickness aluminum oxide layer for can 4 (i.e. treatment of the can with nylon beads, water, citrate and the non-ionic surfactant) is more homogenous, as the standard deviation is substantially reduced compared to the control samples (i.e. cans 1, 2 and 3).

TABLE 6
XPS results for cleaning efficiency

| | | Aluminum | | Aluminum/ |
|---|---|---|---|---|
| | | Metal Content | Carbon | Carbon |
| Sample | Treatment | (%) | Content (%) | Ratio |
| Can 1 | Control Can - | 15.81 | 35.61 | 0.44 |
| | No Treatment | | | |
| Can 2 | Can Treated With | 17.49 | 41.87 | 0.42 |
| | Water Only | | | |
| Can 3 | Water 45 kg + | 16.84 | 40.94 | 0.41 |
| | Citrate 500 g + | | | |
| | Non-ionic | | | |
| | Surfactant 25 g | | | |
| Can 4 | Water 45 kg + | 40.82 | 19.61 | 2.08 |
| | Citrate 500 g + | | | |
| | Non-ionic | | | |
| | Surfactant | | | |
| | 25 g + | | | |
| | Nylon polymeric | | | |
| | particles 10 kg | | | |

The data shown in Table 6 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 6 thus indicates that more aluminum is present on the can surface and that more carbon or contaminant residue has been removed. The can treated with the polymeric particles (i.e. cans 4) showed a significant increase in aluminum/carbon ratio of 2.08 compared to the controls (i.e. cans 1 to 3) demonstrating a dramatically improved cleaning efficiency. The aluminum/carbon ratio for the controls (i.e. cans 1 to 3) were very similar (i.e. in the range 0.41-0.44) which indicated that it was the polymeric particles used that were the essential cleaning component.

The data in Table 7 (below) illustrates the results of XPS analysis for the amounts of other impurities on the aluminum surface, namely calcium, nitrogen and sodium. The can treated with the polymeric particles (i.e. cans 4) indicated removal of calcium, nitrogen and sodium. In comparison, the controls (i.e. cans 1 to 3) showed relatively high levels of these impurities. This demonstrated a dramatically improved cleaning efficiency for the can treated with the polymeric particles (i.e. cans 4) which again indicated that it was the polymeric particles used that were the essential cleaning component.

TABLE 7
XPS results for cleaning efficiency

| | | Calcium | Nitrogen | Sodium |
|---|---|---|---|---|
| Sample | Treatment | Content (%) | Content (%) | Content (%) |
| Can 1 | Control Can - | 0.23 | 0.93 | 2.75 |
| | No Treatment | | | |
| Can 2 | Can Treated With | 0.58 | 0.83 | 0.40 |
| | Water Only | | | |
| Can 3 | Water 45 kg + | 0.24 | 1.27 | 1.50 |
| | Citrate 500 g + | | | |
| | Non-ionic | | | |
| | Surfactant 25 g | | | |
| Can 4 | Water 45 kg + | 0.00 | 0.00 | 0.00 |
| | Citrate 500 g + | | | |
| | Non-ionic | | | |
| | Surfactant 25 g + | | | |
| | Nylon polymeric | | | |
| | particles 10 kg | | | |

### Experiment 3

### Steel Cleaning and Iron Oxide Removal Using an Apparatus Fitted with Pumping Means

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated 1 mm thick mild steel sheet was supplied by Metals 4U Limited, Pontefract, UK.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 8. The mild steel samples were fixed by means of a clamp. Each mild steel sample was inserted into the vessel containing the treatment liquor. The mild steel samples were then subjected to contact with the pumped liquor for a period of 1 or 2 minutes at a temperature of about 22° C., ensuring contact between the mild steel sample and the treatment liquor. After treatment, the mild steel samples were washed with Milli-Q™ water and isopropanol and subjected to XPS analysis.

TABLE 8
Sample Details and Formulation Components.

| Sample | Formulation components/treatment |
|---|---|
| Mild steel 1 | Control - No Treatment |
| Mild steel 2 | Control Treated With Water Only |
| Mild steel 3 | 2 Minute Control Treatment |
| | Water 45 kg + |
| | Citrate 500 g + |
| | Non-ionic Surfactant 25 g |
| Mild steel 4 | 2 Minute Treatment |
| | Water 45 kg + |
| | Citrate 500 g + |
| | Non-ionic Surfactant 25 g + |
| | Nylon polymeric particles 10 kg |
| Mild steel 5 | 1 Minute Control Treatment |
| | Water 45 kg + |
| | Citrate 500 g + |
| | Non-ionic Surfactant 25 g |
| Mild steel 6 | 1 Minute Treatment |
| | Water 45 kg + |
| | Citrate 500 g + |
| | Non-ionic Surfactant 25 g + |
| | Nylon polymeric particles 10 kg |

TABLE 9
XPS results for iron oxide removal

| | | Iron/Iron Oxide |
|---|---|---|
| Sample | Treatment | Ratio |
| Mild steel 1 | Control - No Treatment | 0.03 |
| Mild steel 2 | Control Treated With Water Only | 0.10 |
| Mild steel 3 | 2 Minute Control Treatment | 0.13 |
| | Water 45 kg + | |
| | Citrate 500 g + | |
| | Non-ionic Surfactant 25 g | |
| Mild steel 4 | 2 Minute Treatment | 0.16 |
| | Water 45 kg + | |
| | Citrate 500 g + | |
| | Non-ionic Surfactant 25 g + | |
| | Nylon polymeric particles 10 kg | |
| Mild steel 5 | 1 Minute Control Treatment | 0.14 |
| | Water 45 kg + | |
| | Citrate 500 g + | |
| | Non-ionic Surfactant 25 g | |
| Mild steel 6 | 1 Minute Treatment | 0.16 |
| | Water 45 kg + | |
| | Citrate 500 g + | |
| | Non-ionic Surfactant 25 g + | |
| | Nylon polymeric particles 10 kg | |

The data shown in Table 9 illustrates the results of XPS analysis for the ratio of iron oxide to iron metal on the mild steel surface following the various treatments. As shown by the results for samples 4 and 6 (treatment with nylon particles and formulation for 2 and 1 minutes respectively), compared to control samples without nylon particles there was demonstrated a relative decrease in the iron oxide area (%) and a relative increase in the iron metal area (%), shown by the higher iron/iron oxide ratio compared to the controls. Thus the use of nylon particles has demonstrated good removal of iron oxide from an uncoated mild steel surface.

TABLE 10
XPS results for cleaning efficiency

| | | | | Iron/ |
|---|---|---|---|---|
| | | Iron Metal | Carbon | Carbon |
| Sample | Treatment | Content (%) | Content (%) | Ratio |
| Mild steel 1 | Control - No | 1.61 | 73.90 | 0.02 |
| | Treatment | | | |
| Mild steel 2 | Control Treated | 3.99 | 64.97 | 0.06 |
| | With Water Only | | | |
| Mild steel 3 | 2 Minute Control | 17.43 | 32.55 | 0.54 |
| | Treatment | | | |
| | Water 45 kg + | | | |
| | Citrate 500 g + | | | |
| | Non-ionic | | | |
| | Surfactant 25 g | | | |
| Mild steel 4 | 2 Minute Treatment | 19.91 | 26.88 | 0.74 |
| | Water 45 kg + | | | |
| | Citrate 500 g + | | | |
| | Non-ionic | | | |
| | Surfactant 25 g + | | | |
| | Nylon polymeric | | | |
| | particles 10 kg | | | |
| Mild steel 5 | 1 Minute Control | 14.16 | 36.19 | 0.39 |
| | Treatment | | | |
| | Water 45 kg + | | | |
| | Citrate 500 g + | | | |
| | Non-ionic | | | |
| | Surfactant 25 g | | | |
| Mild steel 6 | 1 Minute Treatment | 20.19 | 28.89 | 0.70 |
| | Water 45 kg + | | | |
| | Citrate 500 g + | | | |
| | Non-ionic | | | |
| | Surfactant 25 g + | | | |
| | Nylon polymeric | | | |
| | particles 10 kg | | | |

The data shown in Table 10 illustrates the results of XPS analysis for the amount of iron metal and carbon on the mild steel surface following the various treatments. The amount of carbon can serve as a surrogate measure for the presence of contaminants (e.g. smut). A higher iron/carbon ratio as indicated in Table 10 thus indicates that more iron is present on the mild steel surface and that more carbon or contaminant residue has been removed. The mild steel sample treated with the polymeric particles for 1 and 2 minutes (i.e. samples 4 and 6) showed a significant increase in iron/carbon ratio of compared to the controls (i.e. mild steel samples 1, 2, 3 and 5) demonstrating an improved cleaning efficiency. Indeed the mild steel samples treated with the formulation without beads for 1 and 2 minutes (i.e. samples 3 and 5) showed a lower iron/carbon ratio than the equivalent mild steel samples treated with the polymeric particles for 1 and 2 minutes (i.e. samples 4 and 6). This indicated that it was the polymeric particles used that were the essential cleaning component in the formulation.

The data in Table 11 illustrates the results of XPS analysis for the amounts of another impurity on the mild steel sample surfaces, namely nitrogen. The mild steel samples treated with the polymeric particles (i.e. mild steel samples 4 and 6) indicated effective removal of nitrogen. In comparison, the controls (i.e. mild steel samples 1, 2, 3 and 5) showed relatively high levels of these nitrogen containing impurities. This demonstrated an improved cleaning efficiency for the mild steel samples treated with the polymeric particles (i.e. samples 4 and 6) even for low treatment periods of 1 and 2 minutes, which again indicated that it was the polymeric particles used that were the essential cleaning component.

TABLE 11
XPS results for cleaning efficiency

| Sample | Treatment | Nitrogen Content (%) |
|---|---|---|
| Mild steel 1 | Control - No Treatment | 0.00 |
| Mild steel 2 | Control Treated With Water Only | 0.81 |
| Mild steel 3 | 2 Minute Control Treatment | 1.14 |
| | Water 45 kg + | |
| | Citrate 500 g + | |
| | Non-ionic Surfactant 25 g | |
| Mild steel 4 | 2 Minute Treatment | 0.00 |
| | Water 45 kg + | |
| | Citrate 500 g + | |
| | Non-ionic Surfactant 25 g + | |
| | Nylon polymeric particles 10 kg | |
| Mild steel 5 | 1 Minute Control Treatment | 0.99 |
| | Water 45 kg + | |
| | Citrate 500 g + | |
| | Non-ionic Surfactant 25 g | |
| Mild steel 6 | 1 Minute Treatment | 0.00 |
| | Water 45 kg + | |
| | Citrate 500 g + | |
| | Non-ionic Surfactant 25 g + | |
| | Nylon polymeric particles 10 kg | |

### Experiment 4

### Experiments to Investigate Steel Cleaning & Iron Oxide Removal Using an Apparatus Fitted with Pumping Means with Alternative Surfactant, PET Polymer Particles and Benzotriazole Corrosion Inhibitor

The ingredients were Perlastan™ ON-60 (i.e. 60% aqueous solution of sodium oleoylsarcosinate) (25.0 g), a anionic surfactant supplied by Surfachem Limited, Leeds, UK and the citrate component consisted of trisodium citrate dihydrate (500.0 g) supplied by VWR, Loughborough, UK. The corrosion inhibitor was Surfac™ 8678 (a 1-10% aqueous solution of benzotriazole) supplied by Surfachem Limited, Leeds, UK. The polymeric particles were polyethylene terephthalate (PET) grade 101 supplied by Teknor Apex, UK in the form of beads. The mass of the polymeric particles used in the apparatus was 10 kg. Uncoated 1 mm thick mild steel sheet was supplied by Metals 4U Limited, Pontefract, UK.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 12. The mild steel samples were fixed by means of a clamp. Each mild steel sample was inserted into the vessel containing the treatment liquor. The mild steel samples were then subjected to contact with the pumped liquor for a period of 1 or 2 minutes at a temperature of 22° C., ensuring contact between the mild steel sample and the treatment liquor. After treatment, the mild steel samples were washed with Milli-Q™ water and isopropanol and subjected to XPS analysis.

TABLE 12
Sample Details and Formulation Components.

| Sample | Formulation components/treatment |
|---|---|
| Mild steel 1 | Control - No Treatment |
| Mild steel 2 | Control Treated With Water Only |
| Mild steel 3 | 1 Minute Control Treatment |
| | Water 45 kg + Citrate 500 g + |
| | Perlastan ™ ON-60 25 g + |
| | Surfac ™ B678 25 g |
| Mild steel 4 | 1 Minute Treatment |
| | Water 45 kg + Citrate 500 g + |
| | Perlastan ™ ON-60 25 g + |
| | Surfac ™ B678 25 g + |
| | PET polymeric particles 10 kg |

TABLE 13
XPS results for iron oxide removal

| | | Iron/Iron Oxide |
|---|---|---|
| Sample | Treatment | Ratio |
| Mild steel 1 | Control - No Treatment | 0.03 |
| Mild steel 2 | Control Treated With Water | 0.10 |
| | Only | |
| Mild steel 3 | 1 Minute Control Treatment | 0.15 |
| | Water 45 kg + | |
| | Citrate 500 g + | |
| | Perlastan ™ ON-60 25 g + | |
| | Surfac ™ B678 25 g | |
| Mild steel 4 | 1 Minute Treatment | 0.16 |
| | Water 45 kg + | |
| | Citrate 500 g + | |
| | Perlastan ™ ON-60 25 g + | |
| | Surfac ™ B678 25 g + | |
| | PET polymeric particles | |
| | 10 kg | |

The data shown in Table 13 illustrates the results of XPS analysis for the ratio of iron oxide to iron metal on the mild steel surface following the various treatments. As shown by the results for samples 4 (treatment with PET particles and formulation for 1 minute), compared to control samples without PET particles there was demonstrated a decrease in the iron oxide area (%) and an increase in the iron metal area (%), shown by the higher iron/iron oxide ratio compared to the controls. Thus the use of PET particles has demonstrated removal of iron oxide from an uncoated mild steel surface. It should be noted that the mild steel samples were not pre-corroded and were used immediately as supplied.

TABLE 14
XPS results for cleaning efficiency

| | | | Carbon | |
|---|---|---|---|---|
| | | Iron Metal | Content | Iron/Carbon |
| Sample | Treatment | Content (%) | (%) | Ratio |
| Mild steel 1 | Control - No | 1.61 | 73.90 | 0.02 |
| | Treatment | | | |
| Mild steel 2 | Control Treated | 3.99 | 64.97 | 0.06 |
| | With Water Only | | | |
| Mild steel 3 | 1 Minute Control | 8.40 | 43.34 | 0.19 |
| | Treatment | | | |
| | Water 45 kg + | | | |
| | Citrate 500 g + | | | |
| | Perlastan ON-60 | | | |
| | 25 g + | | | |
| | Surfac B678 25 g | | | |
| Mild steel 4 | 1 Minute Treatment | 15.24 | 36.71 | 0.42 |
| | Water 45 kg + | | | |
| | Citrate 500 g + | | | |
| | Perlastan ON-60 | | | |
| | 25 g + | | | |
| | Surfac B678 25 g + | | | |
| | PET polymeric | | | |
| | particles 10 kg | | | |

The data shown in Table 14 illustrates the results of XPS analysis for the amount of iron metal and carbon on the mild steel surface following the various treatments. The amount of carbon can serve as a surrogate measure for the presence of contaminants (e.g. smut). A higher iron/carbon ratio as indicated in Table 14 thus indicates that more iron is present on the mild steel surface and that more carbon or contaminant residue has been removed. The mild steel sample treated with the polymeric particles for 1 minute (i.e. sample 4) showed a significant increase in iron/carbon ratio of compared to the controls (i.e. mild steel samples 1, 2 and 3) demonstrating an improved cleaning efficiency. Indeed the mild steel samples treated with the formulation without beads for 1 minute (i.e. sample 3) showed a lower iron/carbon ratio than the equivalent mild steel samples treated with the polymeric particles for 1 minute (i.e. sample 4). This indicated that it was the PET polymeric particles used that were an effective cleaning component in the formulation.

The data in Table 15 illustrates the results of XPS analysis for the amounts of another impurity on the mild steel sample surfaces, namely nitrogen and calcium. The mild steel sample treated with the polymeric particles (i.e. mild steel samples 4) indicated effective removal of nitrogen and calcium. In comparison, the controls (i.e. mild steel samples 1, 2 and 3) showed relatively high levels of these nitrogen and calcium containing impurities. This demonstrated an improved cleaning efficiency for the mild steel samples treated with the polymeric particles (i.e. sample 4) even for low treatment periods of 1 minutes, which again indicated that it was the polymeric particles used that were the essential cleaning component.

TABLE 15
XPS results for cleaning efficiency

| | | Calcium | Nitrogen |
|---|---|---|---|
| | | Content | Content |
| Sample | Treatment | (%) | (%) |
| Mild steel 1 | Control - No Treatment | 0.55 | 0.00 |
| Mild steel 2 | Control Treated With | 0.71 | 0.81 |
| | Water Only | | |
| Mild steel 3 | 1 Minute Control Treatment | 1.73 | 1.31 |
| | Water 45 kg + | | |
| | Citrate 500 g + | | |
| | Perlastan ON-60 25 g + | | |
| | Surfac B678 25 g | | |
| Mild steel 4 | 1 Minute Treatment | 0.00 | 0.00 |
| | Water 45 kg + | | |
| | Citrate 500 g + | | |
| | Perlastan ON-60 25 g + | | |
| | Surfac B678 25 g + | | |
| | PET polymeric particles | | |
| | 10 kg | | |

### Experiment 5

### Experiment to Investigate Iron Oxide Removal from Mild Steel Using an Apparatus Fitted with Pumping Means with Non-Ionic Surfactant and Nylon Polymer Particles

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated 1 mm thick mild steel sheet was supplied by Metals 4U Limited, Pontefract, UK and were pre-corroded by immersion for 10 seconds in a mixture of 1% w/w sulphuric acid, 0.1% w/w salt and 0.3% w/w hydrogen peroxide followed by washing with deionized water and isopropanol.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 16. The mild steel samples were fixed by means of a clamp. Each mild steel sample was inserted into the vessel containing the treatment liquor. The mild steel samples were then subjected to contact with the pumped liquor for a period of 1, 2 or 5 minutes at a temperature of 22° C., ensuring contact between the mild steel sample and the treatment liquor. After treatment, the mild steel samples were washed with Milli-Q™ water and isopropanol and subjected to XPS analysis.

TABLE 16
Sample Details And Formulation Components.

| Sample | Formulation components/treatment |
|---|---|
| Pre-Corroded Mild | Control - No Treatment |
| steel 1 | |
| Pre-Corroded Mild | Control Treated With Water Only |
| steel 2 | |
| Pre-Corroded Mild | 5 Minute Control Treatment |
| steel 3 | Water 45 kg + |
| | Citrate 500 g + |
| | Non-ionic Surfactant 25 g |
| Pre-Corroded Mild | 5 Minute Treatment |
| steel 4 | Water 45 kg + |
| | Citrate 500 g + |
| | Non-ionic Surfactant 25 g + |
| | Nylon polymeric particles 10 kg |
| Pre-Corroded Mild | 2 Minute Control Treatment |
| steel 5 | Water 45 kg + |
| | Citrate 500 g + |
| | Non-ionic Surfactant 25 g |
| Pre-Corroded Mild | 2 Minute Treatment |
| steel 6 | Water 45 kg + |
| | Citrate 500 g + |
| | Non-ionic Surfactant 25 g + |
| | Nylon polymeric particles 10 kg |
| Pre-Corroded Mild | 1 Minute Control Treatment |
| steel 7 | Water 45 kg + |
| | Citrate 500 g + |
| | Non-ionic Surfactant 25 g |
| Pre-Corroded Mild | 1 Minute Treatment |
| steel 8 | Water 45 kg + |
| | Citrate 500 g + |
| | Non-ionic Surfactant 25 g + |
| | Nylon polymeric particles 10 kg |

TABLE 17
XPS results for iron oxide removal

| | | Iron/Iron |
|---|---|---|
| | | Oxide |
| Sample | Treatment | Ratio |
| Pre-Corroded Mild steel 1 | Control - No Treatment | 0.0 |
| Pre-Corroded Mild steel 2 | Control Treated With Water | 0.0 |
| | Only | |
| Pre-Corroded Mild steel 3 | 5 Minute Control Treatment | 0.0 |
| | Water 45 kg + | |
| | Citrate 500 g + | |
| | Non-ionic Surfactant 25 g | |
| Pre-Corroded Mild steel 4 | 5 Minute Treatment | 0.14 |
| | Water 45 kg + | |
| | Citrate 500 g + | |
| | Non-ionic Surfactant 25 g + | |
| | Nylon polymeric particles 10 kg | |
| Pre-Corroded Mild steel 5 | 2 Minute Control Treatment | 0.0 |
| | Water 45 kg + | |
| | Citrate 500 g + | |
| | Non-ionic Surfactant 25 g | |
| Pre-Corroded Mild steel 6 | 2 Minute Treatment | 0.07 |
| | Water 45 kg + | |
| | Citrate 500 g + | |
| | Non-ionic Surfactant 25 g + | |
| | Nylon polymeric particles 10 kg | |
| Pre-Corroded Mild steel 7 | 1 Minute Control Treatment | 0.0 |
| | Water 45 kg + | |
| | Citrate 500 g + | |
| | Non-ionic Surfactant 25 g | |
| Pre-Corroded Mild steel 8 | 1 Minute Treatment | 0.05 |
| | Water 45 kg + | |
| | Citrate 500 g + | |
| | Non-ionic Surfactant 25 g + | |
| | Nylon polymeric particles 10 kg | |

The data shown in Table 17 illustrates the results of XPS analysis for the ratio of iron oxide to iron metal on the mild steel surface following the various treatments. As shown by the results for samples 4, 6 and 8 (treatment with nylon particles and formulation for 5, 2 and 1 minute respectively), compared to control samples without nylon particles there was demonstrated a decrease in the iron oxide area (%) and an increase in the iron metal area (%), shown by the higher iron/iron oxide ratio compared to the controls. Thus the use of nylon particles has demonstrated removal of iron oxide from an uncoated mild steel surface.

### Experiment 6

### Further Experiment to Investigate Iron Oxide Removal from Mild Steel Using an Apparatus Fitted with Pumping Means with Alternative Surfactant, PET Polymer Particles and Benzotriazole Corrosion Inhibitor

The ingredients were Perlastan™ ON-60 (i.e. 60% aqueous solution of sodium oleoylsarcosinate) (25.0 g), a anionic surfactant supplied by Surfachem Limited, Leeds, UK and the citrate component consisted of trisodium citrate dihydrate (500.0 g) supplied by VWR, Loughborough, UK. The corrosion inhibitor was Surfac™ 8678 (a 1-10% aqueous solution of benzotriazole) supplied by Surfachem Limited, Leeds, UK. The polymeric particles were polyethylene terephthalate (PET) grade 101 supplied by Teknor Apex, UK in the form of beads. The mass of the polymeric particles used in the apparatus was 10 kg. Uncoated 1 mm thick mild steel sheet was supplied by Metals 4U Limited, Pontefract, UK, and were pre-corroded by immersion for 10 seconds in a mixture of 1% w/w sulphuric acid, 0.1% w/w salt and 0.3% w/w hydrogen peroxide followed by washing with deionized water and Isopropanol.

XPS analysis was carried out with a Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 18. The mild steel samples were fixed by means of a clamp. Each mild steel sample was inserted into the vessel containing the treatment liquor. The mild steel samples were then subjected to contact with the pumped liquor for a period of 1, 5 or 10 minutes at a temperature of 22° C., ensuring contact between the mild steel sample and the treatment liquor. After treatment, the mild steel samples were washed with Milli-Q™ water and isopropanol and subjected to XPS analysis.

TABLE 18
Sample Details and Formulation Components.

| Sample | Formulation components/treatment |
|---|---|
| Pre-Corroded Mild steel 1 | Control - No Treatment |
| Pre-Corroded Mild steel 2 | Control Treated With Water Only |
| Pre-Corroded Mild steel 3 | 10 Minute Control Treatment |
| | Water 45 kg + Citrate 500 g + |
| | Perlastan ™ ON-60 25 g + |
| | Surfac ™ B678 25 g |
| Pre-Corroded Mild steel 4 | 10 Minute Treatment |
| | Water 45 kg + Citrate 500 g + |
| | Perlastan ™ ON-60 25 g + |
| | Surfac ™ B678 25 g + |
| | PET polymeric particles 10 kg |
| Pre-Corroded Mild steel 5 | 5 Minute Control Treatment |
| | Water 45 kg + Citrate 500 g + |
| | Perlastan ™ ON-60 25 g + |
| | Surfac ™ B678 25 g |
| Pre-Corroded Mild steel 6 | 5 Minute Treatment |
| | Water 45 kg + Citrate 500 g + |
| | Perlastan ™ ON-60 25 g + |
| | Surfac ™ B678 25 g + |
| | PET polymeric particles 10 kg |
| Pre-Corroded Mild steel 7 | 1 Minute Control Treatment |
| | Water 45 kg + Citrate 500 g + |
| | Perlastan ™ ON-60 25 g + |
| | Surfac ™ B678 25 g |
| Pre-Corroded Mild steel 8 | 1 Minute Treatment |
| | Water 45 kg + Citrate 500 g + |
| | Perlastan ™ ON-60 25 g + |
| | Surfac ™ B678 25 g + |
| | PET polymeric particles 10 kg |

TABLE 19
XPS results for iron oxide removal

| | | Iron/Iron |
|---|---|---|
| | | Oxide |
| Sample | Treatment | Ratio |
| Pre-Corroded Mild steel 1 | Control - No Treatment | 0.0 |
| Pre-Corroded Mild steel 2 | Control Treated With Water | 0.0 |
| | Only | |
| Pre-Corroded Mild steel 3 | 10 Minute Control Treatment | 0.0 |
| | Water 45 kg + Citrate 500 g + | |
| | Perlastan ™ ON-60 25 g + | |
| | Surfac ™ B678 25 g | |
| Pre-Corroded Mild steel 4 | 10 Minute Treatment | 0.08 |
| | Water 45 kg + Citrate 500 g + | |
| | Perlastan ™ ON-60 25 g + | |
| | Surfac ™ B678 25 g + | |
| | PET polymeric particles 10 kg | |
| Pre-Corroded Mild steel 5 | 5 Minute Control Treatment | 0.0 |
| | Water 45 kg + Citrate 500 g + | |
| | Perlastan ™ ON-60 25 g + | |
| | Surfac ™ B678 25 g | |
| Pre-Corroded Mild steel 6 | 5 Minute Treatment | 0.04 |
| | Water 45 kg + Citrate 500 g + | |
| | Perlastan ™ ON-60 25 g + | |
| | Surfac ™ B678 25 g + | |
| | PET polymeric particles 10 kg | |
| Pre-Corroded Mild steel 7 | 1 Minute Control Treatment | 0.0 |
| | Water 45 kg + Citrate 500 g + | |
| | Perlastan ™ ON-60 25 g + | |
| | Surfac ™ B678 25 g | |
| Pre-Corroded Mild steel 8 | 1 Minute Treatment | 0.01 |
| | Water 45 kg + Citrate 500 g + | |
| | Perlastan ™ ON-60 25 g + | |
| | Surfac ™ B678 25 g + | |
| | PET polymeric particles 10 kg | |

The data shown in Table 19 illustrates the results of XPS analysis for the ratio of iron oxide to iron metal on the mild steel surface following the various treatments. As shown by the results for samples 4, 6 and 8 (treatment with polyester PET particles and formulation for 10, 5 and 1 minute respectively), compared to control samples without polyester PET particles there was demonstrated a decrease in the iron oxide area (%) and an increase in the iron metal area (%), shown by the higher iron/iron oxide ratio compared to the controls. Thus the use of polyester PET particles has demonstrated removal of iron oxide from an uncoated mild steel surface.

### Experiment 7

### Aluminum Cleaning & Oxide Removal Using an Apparatus Fitted with Pumping Means

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Nylon 6,6 grade Technyl™ XA1493 supplied by Solvay, Lyon, France in the form of beads. The mass of the polymeric particles used in the apparatus was 10 kg. Uncoated aluminum metal cans grade ALJSC60ML63X15 were supplied by Invopak UK Ltd. Hyde, Cheshire.

XPS analysis was carried out with an Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to Correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 20. Aluminum cans were fixed to a metal rod which was fixed by means of a clamp. Each can was inserted into the vessel containing the treatment liquor. The cans were then subjected to contact with the pumped liquor for a period of 1, 2 and 5 minutes at a temperature of 22° C., ensuring contact between the can and the treatment liquor. After treatment, the cans were washed with Milli-Q™ water and isopropanol and subjected to XPS analysis.

TABLE 20
Sample Details and Formulation Components.

| Sample | Formulation components/treatment |
|---|---|
| Can 1 | Control Can - No Treatment |
| Can 2 | Can Treated With Water Only |
| Can 3 | 5 Minute Control |
| | Water 45 kg + |
| | Citrate 500 g + |
| | Non-ionic Surfactant 25 g |
| Can 4 | 5 Minute Treatment |
| | Water 45 kg + |
| | Citrate 500 g + |
| | Non-ionic Surfactant 25 g + |
| | Nylon polymeric particles 10 kg |
| Can 5 | 2 Minute Control |
| | Water 45 kg + |
| | Citrate 500 g + |
| | Non-ionic Surfactant 25 g |
| Can 6 | 2 Minute Treatment |
| | Water 45 kg + |
| | Citrate 500 g + |
| | Non-ionic Surfactant 25 g + |
| | Nylon polymeric particles 10 kg |
| Can 7 | 1 Minute Control |
| | Water 45 kg + |
| | Citrate 500 g + |
| | Non-ionic Surfactant 25 g |
| Can 8 | 1 Minute Treatment |
| | Water 45 kg + |
| | Citrate 500 g + |
| | Non-ionic Surfactant 25 g + |
| | Nylon polymeric particles 10 kg |

TABLE 21
XPS results for aluminum oxide removal

| | | | | Aluminum |
|---|---|---|---|---|
| | | Aluminum | Aluminum | Oxide |
| | | Oxide | Metal | layer |
| | | Area | Area | Thickness |
| Sample | Treatment | (%) | (%) | (nm) |
| Can 1 | Control Can - No | 97.70 | 2.31 | 11.49 |
| | Treatment | | | |
| Can 2 | Can Treated With Water | 94.38 | 5.63 | 8.94 |
| | Only | | | |
| Can 3 | 5 Minute Control | 95.74 | 4.26 | 9.73 |
| | Water 45 kg + | | | |
| | Citrate 500 g + | | | |
| | Non-ionic Surfactant 25 g | | | |
| Can 4 | 5 Minute Treatment | 79.24 | 20.75 | 5.16 |
| | Water 45 kg + | | | |
| | Citrate 500 g + | | | |
| | Non-ionic Surfactant 25 g + | | | |
| | Nylon polymeric particles | | | |
| | 10 kg | | | |
| Can 5 | 2 Minute Control | 91.60 | 8.39 | 7.80 |
| | Water 45 kg + | | | |
| | Citrate 500 g + | | | |
| | Non-ionic Surfactant 25 g | | | |
| Can 6 | 2 Minute Treatment | 83.30 | 16.71 | 5.80 |
| | Water 45 kg + | | | |
| | Citrate 500 g + | | | |
| | Non-ionic Surfactant 25 g + | | | |
| | Nylon polymeric particles | | | |
| | 10 kg | | | |
| Can 7 | 1 Minute Control | 96.64 | 3.36 | 10.40 |
| | Water 45 kg + | | | |
| | Citrate 500 g + | | | |
| | Non-ionic Surfactant 25 g | | | |
| Can 8 | 1 Minute Treatment | 66.59 | 33.41 | 3.72 |
| | Water 45 kg + | | | |
| | Citrate 500 g + | | | |
| | Non-ionic Surfactant 25 g + | | | |
| | Nylon polymeric particles | | | |
| | 10 kg | | | |

The data shown in Table 21 illustrates the results of XPS analysis for the amount of aluminum oxide and aluminum metal on the can surface following the various treatments. The thickness of the aluminum oxide layer was calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for can 4, 6 and 8 treatment of the can with nylon beads, water, citrate and the non-ionic surfactant demonstrated a significant decrease in the aluminum oxide area (%) and a significant increase in the aluminum metal area (%) for the surface of the metal substrate compared to the controls (i.e. cans 1, 2, 3, 5 and 7). Furthermore, an aluminum oxide layer of significantly reduced thickness was obtained for can 8 (3.72 nm) which was subjected only to 1 minute treatment compared to the controls and especially when compared to the treatment with citrate, Mulan™ and water alone for 1 minute (Can 7).

TABLE 22
XPS results for cleaning efficiency

| | | Aluminum | | Alu- |
|---|---|---|---|---|
| | | Metal | Carbon | minum/ |
| | | Content | Content | Carbon |
| Sample | Treatment | (%) | (%) | Ratio |
| Can 1 | Control Can - No Treatment | 15.81 | 35.61 | 0.44 |
| Can 2 | Can Treated With Water Only | 17.49 | 41.87 | 0.42 |
| Can 3 | 5 Minute Control | 18.24 | 28.64 | 0.64 |
| | Water 45 kg + Citrate 500 g + | | | |
| | Non-ionic Surfactant 25 g | | | |
| Can 4 | 5 Minute Treatment | 33.08 | 18.50 | 1.79 |
| | Water 45 kg + Citrate 500 g + | | | |
| | Non-ionic Surfactant 25 g + | | | |
| | Nylon polymeric particles 10 kg | | | |
| Can 5 | 2 Minute Control | 22.07 | 30.44 | 0.72 |
| | Water 45 kg + Citrate 500 g + | | | |
| | Non-ionic Surfactant 25 g | | | |
| Can 6 | 2 Minute Treatment | 31.63 | 20.37 | 1.55 |
| | Water 45 kg + Citrate 500 g + | | | |
| | Non-ionic Surfactant 25 g + | | | |
| | Nylon polymeric particles 10 kg | | | |
| Can 7 | 1 Minute Control | 17.72 | 31.39 | 0.56 |
| | Water 45 kg + Citrate 500 g + | | | |
| | Non-ionic Surfactant 25 g | | | |
| Can 8 | 1 Minute Treatment | 39.13 | 18.30 | 2.14 |
| | Water 45 kg + Citrate 500 g + | | | |
| | Non-ionic Surfactant 25 g + | | | |
| | Nylon polymeric particles 10 kg | | | |

The data shown in Table 22 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 22 thus indicates that more aluminum is present on the can surface and that more carbon or contaminant residue has been removed. The cans treated with the polymeric particles (i.e. cans 4, 6 and 8) showed a significant increase in aluminum/carbon ratio compared to the controls (i.e. cans 1, 2, 3, 5 and 7) demonstrating a dramatically improved cleaning efficiency.

TABLE 23
XPS results for cleaning efficiency

| | | Nitrogen | Sodium |
|---|---|---|---|
| Sample | Treatment | Content (%) | Content (%) |
| Can 1 | Control Can - No Treatment | 0.93 | 2.75 |
| Can 2 | Can Treated With Water Only | 0.83 | 0.40 |
| Can 3 | 5 Minute Control | 1.47 | 3.56 |
| | Water 45 kg + Citrate 500 g + | | |
| | Non-ionic Surfactant 25 g | | |
| Can 4 | 5 Minute Treatment | 0.0 | 0.39 |
| | Water 45 kg + Citrate 500 g + | | |
| | Non-ionic Surfactant 25 g + | | |
| | Nylon polymeric particles 10 kg | | |
| Can 5 | 2 Minute Control | 0.45 | 2.21 |
| | Water 45 kg + Citrate 500 g + | | |
| | Non-ionic Surfactant 25 g | | |
| Can 6 | 2 Minute Treatment | 0.0 | 0.18 |
| | Water 45 kg + Citrate 500 g + | | |
| | Non-ionic Surfactant 25 g + | | |
| | Nylon polymeric particles 10 kg | | |
| Can 7 | 1 Minute Control | 0.35 | 4.03 |
| | Water 45 kg + Citrate 500 g + | | |
| | Non-ionic Surfactant 25 g | | |
| Can 8 | 1 Minute Treatment | 0.0 | 0.0 |
| | Water 45 kg + Citrate 500 g + | | |
| | Non-ionic Surfactant 25 g + | | |
| | Nylon polymeric particles 10 kg | | |

The data in Table 23 (above) illustrates the results of XPS analysis for the amounts of other impurities on the aluminum surface, namely nitrogen and sodium. The cans treated with the polymeric particles (i.e. cans 4, 6 and 8) indicated effective removal of nitrogen and sodium. In comparison, the controls showed relatively high levels of these impurities. This demonstrated a dramatically improved cleaning efficiency for the cans treated with the polymeric particles (i.e. cans 4, 6 and 8) which again indicated that it was the polymeric particles used that were the essential cleaning component.

### Experiment 8

### Aluminum Cleaning & Oxide Removal Using an Apparatus Fitted with Pumping Means

The ingredients were Mulan™ 200S (25.0 g), a non-ionic surfactant supplied by Christeyns, Bradford, UK and the citrate component consisted of trisodium citrate dihydrate (500.0 g) supplied by VWR, Loughborough, UK. The polymeric particles were Polyester (PET) supplied by Teknor Apex, UK, in the form of beads. The mass of the polymeric particles used in the apparatus was 10 kg. Uncoated aluminum metal cans grade ALJSC60ML63X15 were supplied by Invopak UK Ltd. Hyde, Cheshire.

XPS analysis was carried out with an Axis Ultra DLD, using an Al kα monochromated radiation source. An overall survey scan was taken initially, followed by detailed scans of the main peaks for the elements identified, using a pass energy of 160 eV and 20 eV respectively. The measured data was fitted using Casa XPS (Casa Software Ltd, UK), using relative sensitivity factors based upon the scheme where C1s=1, and adjusted to correct for any minor charging using the aliphatic carbon peak at 285 eV. Each sample was measured in 2 places.

In order to carry out the experiments, the treatment liquor was added to a vessel containing a pump. The treatment liquor consisted of the polymeric particles (of total mass 10 kg) and tap water (45 kg) and the further formulation components as shown in Table 24. Aluminum cans were fixed to a metal rod which was fixed by means of a clamp. Each can was inserted into the vessel containing the treatment liquor. The cans were then subjected to contact with the pumped liquor for a period of 1, 2 and 5 minutes at a temperature of 22° C., ensuring contact between the can and the treatment liquor. After treatment, the cans were washed with Milli-Q™ water and isopropanol and subjected to XPS analysis.

TABLE 24
Sample Details And Formulation Components.

| Sample | Formulation components/treatment |
|---|---|
| Can 1 | Control Can - No Treatment |
| Can 2 | Can Treated With Water Only |
| Can 3 | 5 Minute Control |
| | Water 45 kg + |
| | Citrate 500 g + |
| | Non-ionic Surfactant 25 g |
| Can 4 | 5 Minute Treatment |
| | Water 45 kg + |
| | Citrate 500 g + |
| | Non-ionic Surfactant 25 g + |
| | PET polymeric particles 10 kg |
| Can 5 | 2 Minute Control |
| | Water 45 kg + |
| | Citrate 500 g + |
| | Non-ionic Surfactant 25 g |
| Can 6 | 2 Minute Treatment |
| | Water 45 kg + |
| | Citrate 500 g + |
| | Non-ionic Surfactant 25 g + |
| | PET polymeric particles 10 kg |
| Can 7 | 1 Minute Control |
| | Water 45 kg + |
| | Citrate 500 g + |
| | Non-ionic Surfactant 25 g |
| Can 8 | 1 Minute Treatment |
| | Water 45 kg + |
| | Citrate 500 g + |
| | Non-ionic Surfactant 25 g + |
| | PET polymeric particles 10 kg |

TABLE 25
XPS results for aluminum oxide removal

| | | Aluminum | Aluminum | Aluminum |
|---|---|---|---|---|
| | | Oxide Area | Metal Area | Oxide layer |
| Sample | Treatment | (%) | (%) | Thickness (nm) |
| Can 1 | Control Can - | 97.70 | 2.31 | 11.49 |
| | No Treatment | | | |
| Can 2 | Can Treated | 94.38 | 5.63 | 8.94 |
| | With Water Only | | | |
| Can 3 | 5 Minute Control | 95.74 | 4.26 | 9.73 |
| | Water 45 kg + | | | |
| | Citrate 500 g + | | | |
| | Non-ionic | | | |
| | Surfactant 25 g | | | |
| Can 4 | 5 Minute | 84.16 | 15.85 | 5.96 |
| | Treatment | | | |
| | Water 45 kg + | | | |
| | Citrate 500 g + | | | |
| | Non-ionic | | | |
| | Surfactant 25 g + | | | |
| | PET polymeric | | | |
| | particles 10 kg | | | |
| Can 5 | 1 Minute Control | 96.64 | 3.36 | 10.40 |
| | Water 45 kg + | | | |
| | Citrate 500 g + | | | |
| | Non-ionic | | | |
| | Surfactant 25 g | | | |
| Can 6 | 1 Minute | 89.99 | 10.01 | 7.92 |
| | Treatment | | | |
| | Water 45 kg + | | | |
| | Citrate 500 g + | | | |
| | Non-ionic | | | |
| | Surfactant 25 g + | | | |
| | PET polymeric | | | |
| | particles 10 kg | | | |

The data shown in Table 25 illustrates the results of XPS analysis for the amount of aluminum oxide and aluminum metal on the can surface following the various treatments. The thickness of the aluminum oxide layer was calculated in accordance with the standard methods outlined in B. R. Strohmeier, Surf. Interface Anal. 1990, 15, 51 and T. A. Carlson, G. E. McGuire, J. Electron Spectrosc. Relat. Phenom, 1972/73; 1, 161. As shown by the results for cans 4 and 6 treatment of the can with PET beads, water, citrate and the non-ionic surfactant demonstrated a significant decrease in the aluminum oxide area (%) and a significant increase in the aluminum metal area (%) for the surface of the metal substrate compared to the controls.

TABLE 26
XPS results for cleaning efficiency

| | | Aluminum | | Alu- |
|---|---|---|---|---|
| | | Metal | Carbon | minum/ |
| | | Content | Content | Carbon |
| Sample | Treatment | (%) | (%) | Ratio |
| Can 1 | Control Can - No | 15.81 | 35.61 | 0.44 |
| | Treatment | | | |
| Can 2 | Can Treated With Water Only | 17.49 | 41.87 | 0.42 |
| Can 3 | 5 Minute Control | 18.24 | 28.64 | 0.64 |
| | Water 45 kg + | | | |
| | Citrate 500 g + | | | |
| | Non-ionic Surfactant 25 g | | | |
| Can 4 | 5 Minute Treatment | 33.16 | 19.51 | 1.70 |
| | Water 45 kg + | | | |
| | Citrate 500 g + | | | |
| | Non-ionic Surfactant 25 g + | | | |
| | PET polymeric particles 10 kg | | | |
| Can 5 | 1 Minute Control | 17.72 | 31.39 | 0.56 |
| | Water 45 kg + | | | |
| | Citrate 500 g + | | | |
| | Non-ionic Surfactant 25 g | | | |
| Can 6 | 1 Minute Treatment | 26.04 | 22.70 | 1.15 |
| | Water 45 kg + | | | |
| | Citrate 500 g + | | | |
| | Non-ionic Surfactant 25 g + | | | |
| | PET polymeric particles 10 kg | | | |

The data shown in Table 26 illustrates the results of XPS analysis for the amount of aluminum metal and carbon on the can surface following the various treatments. The amount of carbon can serve as a surrogate measure for the presence of contaminants (e.g. smut). A higher aluminum/carbon ratio as indicated in Table 26 thus indicates that more aluminum is present on the can surface and that more carbon or contaminant residue has been removed. The cans treated with the polymeric particles showed a significant increase in aluminum/carbon ratio compared to the controls demonstrating a dramatically improved cleaning efficiency.

### Experiment 9

### Mild Steel Cleaning & Oxide Removal Using an Apparatus Comprising a Rotating Drum and a Stationary Metal Substrate

The ingredients were Mulan™ 200S (0.6 g), a non-ionic surfactant supplied by Christeyns, Bradford, UK and the citrate component consisted of trisodium citrate dihydrate (12.0 g) supplied by VWR, Loughborough, UK. The corrosion inhibitor was Surfac™ 8678 (a 1-10% aqueous solution of benzotriazole) supplied by Surfachem Limited, Leeds, UK which was added to the liquid components in an amount of 0.5 g. Water was added to these ingredients so as to make the total mass of the treatment formulation up to 100 g (excluding the polymeric particles). The polymeric particles were Nylon 6,6 grade Technyl™ XA1493 supplied by Solvay, Lyon, France in the form of beads. The mass of the polymeric particles used in the apparatus was 1.7 kg. Mild steel 1 mm thick sheet was used as the metal substrate. This prepared a treatment liquor.

Uncoated 1 mm thick mild steel sheet was supplied by Metals 4U Limited, Pontefract, UK and was pre-corroded by immersion for 10 seconds in a mixture of 1% w/w sulphuric acid, 0.1% w/w salt and 0.3% w/w hydrogen peroxide followed by washing with deionized water and isopropanol.

The treatment apparatus used was a BK-0057 rotary tumbler (obtained from geographysuperstore.com). The treatment apparatus was a 5 kg machine fitted with a drum of dimensions 192 mm×180 mm and having a 2 litre capacity. The treatment liquor prepared above in this experiment was loaded into the treatment apparatus.

The pre-corroded mild steel metal substrate was treated in a treatment apparatus comprising a rotating drum filled with the polymeric particles and the liquid components. A portion of the pre-corroded mild steel substrate was covered with a plastic tape. The presence of the plastic tape prevented the beads and liquid components from contacting some of the metal surface thereby helping to show the contrast between treated and untreated surfaces. The drum was rotated for a period of 10 minutes in such a fashion that the polymeric particles contacted the surface of the mild steel.

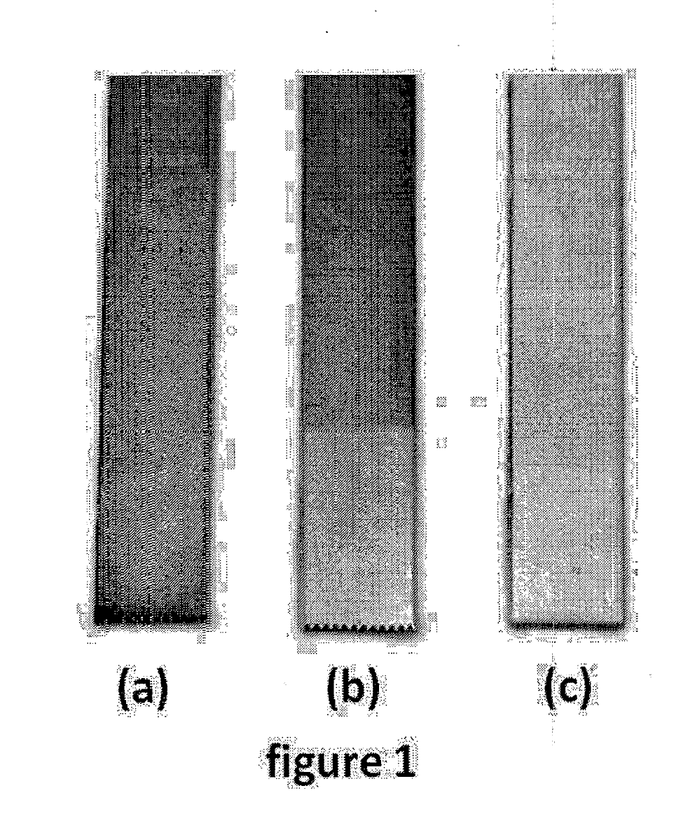

Digital photographs were taken of the un-corroded mild steel substrate, the pre-corroded mild steel substrate and the pre-corroded substrate as treated in this experiment. The results are shown in FIG. 1 wherein (a) is the pre-corroded mild steel substrate, (b) is the pre-corroded mild steel substrate treated as indicated in this experiment and (c) is the un-corroded mild steel substrate. As can be seen from FIG. 1 the pre-corroded mild steel substrate has been successfully cleaned and the pre-corroded oxide layer has been successfully removed. Using a qualitative visual assessment for the remaining amount of oxide layer the results indicated in Table 27 were obtained.

TABLE 27
Visual assessment of the treatment performance using a treatment
apparatus comprising a rotating drum.

| Sample | Visual assessment* |
|---|---|
| Pre-corroded mild steel | 0 |
| Pre-corroded mild steel treated in | 4 |
| Experiment 9 | |
| Un-corroded mild steel | 5 |

*The visual assessment was performed on a scale of from 0 to 5, with 0 representing the fully pre-corroded surface and 5 representing the “clean” un-corroded mild steel surface.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method of cleaning a metal substrate, the method comprising exposing the metal substrate to a body of cleaning liquor comprising a cleaning formulation and a multiplicity of solid particles wherein the method further comprises causing the solid particles and the metal substrate to enter into contacting relative movement; wherein
i) the cleaning formulation comprises at least one acid which has a pKa greater than about −1.7; and/or
ii) the cleaning formulation comprises at least one base which has a pKb greater than about −1.7; and
the length of the particles is from about 0.5 mm to about 6 mm.

2. The method according to claim 1 wherein the cleaning formulation comprises a solvent.

3. The method according to claim 1 or claim 2 wherein the cleaning formulation comprises at least one surfactant.

4. The method according to claim 3 wherein the at least one surfactant is a non-ionic surfactant.

5. The method according to any one of the preceding claims wherein the cleaning formulation comprises at least one acid which has a pKa greater than about −1.7.

6. The method according to claim 5 wherein the at least one acid has a pKa between about −1.7 and about 15.7.

7. The method according to claim 5 or claim 6 wherein the at least one acid is an organic acid.

8. The method according to any one of the preceding claims wherein the cleaning formulation comprises at least one base which has a pKb greater than about −1.7.

9. The method according to claim 8 wherein the at least one base has a pKb between about −1.7 and about 15.7.

10. The method according to any one of the preceding claims wherein the cleaning formulation comprises a compound with at least one carboxylic acid moiety.

11. The method according to any one of the preceding claims wherein the cleaning formulation comprises a compound with two or more carboxylic acid moieties.

12. The method according to any one of the preceding claims wherein the cleaning formulation comprises a compound containing at least one citrate moiety.

13. The method according to any one of the preceding claims wherein the cleaning formulation comprises at least one metal chelating agent.

14. The method according to any one of the preceding claims wherein the cleaning formulation is aqueous.

15. The method according to any one of the preceding claims wherein the cleaning formulation has a pH between about 1 and about 13.

16. The method according to any one of the preceding claims wherein the cleaning formulation has a pH greater than about 7.

17. The method according to any one of the preceding claims wherein at least some of the solid particles are buoyant in the cleaning formulation.

18. The method according to any one of the preceding claims wherein the solid particles have an average density of less than about 1.

19. The method according to any one of the preceding claims wherein the solid particles are in the form of beads.

20. The method according to any one of the preceding claims wherein the method comprises moving the metal substrate such that its surface is brought into contact with the solid particles.

21. The method according to any one of the preceding claims wherein the method comprises rotating, oscillating or reciprocating the metal substrate within the cleaning liquor.

22. The method according to any one of the preceding claims wherein the method comprises scouring the surface of the metal substrate with the solid particles.

23. The method according to any one of the preceding claims wherein the method comprises agitating the solid particles within the cleaning liquor.

24. The method according to any one of the preceding claims wherein the method is carried out using a fluidized bed containing the cleaning liquor.

25. The method according to any one of the preceding claims wherein the cleaning liquor contacts the metal surface at a relative velocity of at least 1 cm per second.

26. The method according to any one of the preceding claims wherein the multiplicity of solid particles comprises or consists of a multiplicity of polymeric particles or wherein the multiplicity of solid particles comprises or consists of a multiplicity of non-polymeric particles.

27. The method according to any one of the preceding claims wherein the multiplicity of solid particles comprises or consists of a mixture of a multiplicity of polymeric particles and a multiplicity of non-polymeric particles.

28. The method according to any one of the preceding claims wherein the multiplicity of solid particles comprises or consists of a multiplicity of polymeric particles.

29. The method according to any of claims 26 to 28 wherein the polymeric particles comprise particles of one or more polar polymers.

30. The method according to any of claims 26 to 28 wherein the polymeric particles comprise particles of one or more non-polar polymers.

31. The method according to any of claims 26 to 28 wherein the polymeric particles comprise particles of one or more polar polymers and particles of one or more non-polar polymers.

32. The method according to any of claims 26 to 31 wherein the polymeric particles comprise particles selected from particles of polyalkenes, polyamides, polyesters, polysiloxanes, polyurethanes or copolymers thereof.

33. The method according to any of claims 26 to 28 or any of claims 30 to 32 wherein the polymeric particles comprise particles selected from particles of polyalkenes or copolymers thereof.

34. The method according to claim 33 wherein the polymeric particles comprise particles of polypropylene.

35. The method according to any of claims 26 to 29, claim 31 or claim 32 wherein the polymeric particles comprise particles selected from polyamide, polyester or copolymers thereof.

36. The method according to claim 35 wherein the polyamide particles comprise particles of nylon.

37. The method according to claim 35 wherein the polyester particles comprise particles of polyethylene terephthalate or polybutylene terephthalate.

38. The method according to claim 26 or 27 wherein the non-polymeric particles comprise particles of ceramic material, refractory material, igneous, sedimentary, metamorphic minerals or composites.

39. The method according to any of claims 26 to 37 wherein the polymeric particles comprise particles selected from linear, branched or cross-linked polymers.

40. The method according to any of claims 26 to 37 and claim 39 wherein the polymeric particles comprise foamed or unfoamed polymers.

41. The method according to any one of the preceding claims wherein the solid particles are of hollow and/or porous construction.

42. The method according to any of claims 26 to 37 or claims 39 and 40 wherein the polymeric particles have an average density of from about 0.5 to about 3.5 g/cm³.

43. The method according to claim 26, 27 or 38, wherein the non-polymeric particles have an average density of from about 3.5 to about 12.0 g/cm³.

44. The method according to any of claims 26 to 43 wherein the polymeric or non-polymeric particles have an average volume in the range of about 5 to about 275 mm³.

45. The method according to any one of the preceding claims wherein the solid particles are reused one or more times for cleaning of metal substrates according to the method of the invention.

46. The method according to any one of the preceding claims wherein the method comprises a step of recovering the multiplicity of solid particles after cleaning of the metal substrate.

47. The method according to any one of the preceding claims wherein the cleaning formulation comprises one or more components selected from the group consisting of: solvents, polymers, corrosion inhibitors, builders, chelating agents, surfactants, dispersants, acids, bases, anti-oxidants, reducing agents, oxidising agents and bleaches.

48. The method according to any one of the preceding claims wherein the method further comprises coating the metal substrate after cleaning the metal substrate.

49. The method according to any one of the preceding claims wherein the metal substrate comprises a transition metal.

50. The method according to any one of the preceding claims wherein the metal substrate comprises aluminum.

51. The method according to any one of the preceding claims wherein the metal substrate is a metal alloy.

52. The method according to claim 51 wherein the metal alloy is an alloy of iron.

53. The method according to any one of the preceding claims wherein the metal substrate comprises a metal sheet.

54. The method according any one of the preceding claims wherein the metal substrate is a can.

55. A method of treating a metal substrate comprising the steps of:
a) cleaning the metal substrate to remove contaminants according to any of claims 1 to 54;
b) removing at least a portion of an oxide layer from the surface of the cleaned substrate.

56. The method according to claim 55 wherein step b) comprises exposing the metal substrate to a treatment liquor comprising a treatment formulation and a multiplicity of solid particles.

57. The method according to claim 56 wherein the method further comprises causing the solid particles and the metal substrate to enter into contacting relative movement.

58. The method according to claim 56 or claim 57 wherein the treatment formulation comprises one or more promoters selected from the group consisting of acids, bases and surfactants.

59. The method according to claim 58 wherein the one or more promoters comprises at least one metal chelating agent.

60. The method according to claim 58 or claim 59 wherein the one or more promoters comprises at least one carboxylic acid moiety.

61. The method according to any of claims 58 to 60 wherein the one or more promoters comprises at least one citrate moiety.

62. The method according to any of claims 58 to 61 wherein the one or more promoters comprises at least one surfactant.

63. The method of claim 62 wherein the at least one surfactant is a non-ionic surfactant.

64. The method according to any of claims 56 to 63 wherein the solid particles in the treatment liquor comprises or consists of a multiplicity of polymeric particles or wherein the solid particles comprise or consist of a multiplicity of non-polymeric particles.

65. The method according to any of claims 56 to 63 wherein the solid particles in the treatment liquor comprises or consists of a multiplicity of polymeric particles.

66. The method according to any of claims 56 to 65 wherein the method of treating the metal substrate comprises passivating the metal substrate.

67. The method according to any of claims 56 to 66 wherein the method of treating the metal substrate comprises inhibiting the re-growth of an oxide layer on the surface of the metal substrate.

68. The method according to any one of the preceding claims wherein the metal substrate is exposed to the cleaning liquor for a period from 1 second to 4 minutes.

69. A cleaning liquor for cleaning a metal substrate comprising a cleaning formulation and a multiplicity of solid particles wherein the cleaning formulation comprises an acid selected from citric acid, gluconic acid, adipic acid, acetic acid, lactic acid, glycolic acid, oxalic acid, formic acid or the alkali metal salts thereof and wherein the length of the particles is from about 0.5 mm to about 6 mm.

70. A cleaning liquor according to claim 69 wherein the cleaning formulation comprises a solvent.

71. A cleaning liquor according to claim 69 or claim 70 wherein the cleaning formulation comprises at least one metal chelating agent.

72. A cleaning liquor according to any one of claims 69 to 71 wherein the cleaning formulation comprises at least one surfactant.

73. A cleaning liquor according to claim 72 wherein the surfactant is a non-ionic surfactant.

74. A cleaning liquor according to claim 72 wherein the surfactant is an anionic surfactant.

75. A cleaning liquor according to any one of claims 69 to 74 wherein the cleaning formulation has a pH of greater than about 7.

76. A cleaning liquor according to any one of claims 69 to 75 wherein the multiplicity of solid particles comprises or consists of a multiplicity of polymeric particles or wherein the multiplicity of solid particles comprises or consists of a multiplicity of non-polymeric particles.

77. A cleaning formulation according to any one of claims 69 to 76 wherein the multiplicity of solid particles comprises or consists of a mixture of a multiplicity of polymeric particles and a multiplicity of non-polymeric particles.

78. A cleaning formulation according to any one of claim 76 the multiplicity of solid particles comprises or consists of polymeric particles.

79. A cleaning formulation according to any one of claims 76 to 78 wherein the polymeric particles comprise particles selected from particles of polyalkenes, polyamides, polyesters, polysiloxanes, polyurethanes or copolymers thereof.
